(19) United States
(12) Patent Application Publication
(10) Pub. No.: US 2016/0282798 A1
(43) Pub. Date: Sep. 29, 2016

(54) TRANSMISSION DEVICE FOR A PHOTOSENSITIVE DRUM

(71) Applicant: Mitsubishi Chemical Corporation, Chiyoda-ku (JP)

(72) Inventors: Yohei Matsuoka, Chiyoda-ku (JP); Shuichi Ikeda, Chiyoda-ku (JP)

(73) Assignees: Mitsubishi Chemical Corporation, Chiyoda-ku (JP); GENERAL PLASTIC INDUSTRIAL CO., LTD., Taichung City (TW)

(21) Appl. No.: 14/666,954

(22) Filed: Mar. 24, 2015

(51) Int. Cl. G03G 15/00

(52) U.S. Cl. CPC G03G 15/757

(57) ABSTRACT

A transmission unit includes a gear member; a sleeve removably attached to the gear member, the sleeve including a guiding groove; and a transmission unit including a shaft having at least one protrusion extending radially outward from the shaft. The guiding groove is shaped such that the protrusion is moveable within the guiding groove in an axial direction and rotatable relative to the guiding groove.

### BACKGROUND

The present disclosure relates to a driving component, a photosensitive drum and a processing cartridge using the driving component.

An electrophotographic image forming apparatus includes a copying machine, a laser printer and other similar devices.

Usually there is a process cartridge in the electrophotographic image forming apparatus. The process cartridge can be mounted to a main assembly of the electrophotographic image forming apparatus and be demounted from the main assembly. For example, the process cartridge is prepared by integrally assembling the photosensitive drum and at least one of a developing device, a charging device, and a cleaning device as the processing device into a cartridge.

Current process cartridges include the following types: a first type of a process cartridge prepared by integrally assembling a photosensitive drum, and a developing device, a charging device and a cleaning device into a cartridge; a second type of a process cartridge prepared by integrally assembling a photosensitive drum and a charging device into a cartridge; and a third type of a process cartridge prepared by integrally assembling a photosensitive drum and two processing units consisting of a charging device and a cleaning device.

A user can mount the above process cartridge to the main assembly of an electrophotographic image forming apparatus in a detachable way. Therefore, the user can maintain the apparatus without relying on a service person. As a result, the user's operability of the maintenance of the electrophotographic image forming apparatus is improved. In the above conventional process cartridge, the mechanism used for receiving a rotational driving force from an apparatus main assembly to rotate a photosensitive drum is described as follows.

On a main assembly side, a rotatable member for transmitting a driving force of a motor and a non-circular twisted hole, which is provided at a center portion of the rotatable member and has a cross section integrally rotatable with the rotatable member and provided with a plurality of corners, are provided.

On a process cartridge side, a non-circular twisted projection, which is provided at one of longitudinal ends of a photosensitive drum and has a cross section provided with a plurality of corners, is provided. When the rotatable member is rotated in an engaged state between the projection and the hole in the case where the process cartridge is mounted to the apparatus main assembly, a rotational driving force of the rotatable member is transmitted to the photosensitive drum. As a result, the rotational force for driving the photosensitive drum is transmitted from the apparatus main assembly to the photosensitive drum. Another known mechanism is to drive a photosensitive drum by engaging a gear fixed to the photosensitive drum thus to drive a process cartridge consisting of the photosensitive drum.

U.S. Pat. No. 8,615,184 and International Patent Publication Nos. WO2012-113299 and WO2012-113289, which are all incorporated by reference herein, show conventional arrangements of the driving components of a photosensitive drum. These driving components couple the photosensitive drum to the apparatus main assembly and transmit the rotational force therefrom, as described further below.

FIG. 40 shows an embodiment of a photosensitive drum 10 constituting a driving component 1. The driving component 1 (also known as a transmission device) is fixed at one end of a main drum body 20 of the photosensitive drum 10. The main drum body 20 has a photosensitive layer at its peripheral surface. The driving component 1 is used to receive a rotational driving force from a printer's driving mechanism and transmit the rotational driving force to the main drum body 20. The main drum body 20 rotates around its axis under the rotational driving force.

FIGS. 41-43 show the basic constructions of the driving component 1, which mainly comprises a gear 2, a rotational driving force receiver 3, a regulating slider 4, a groove part 5, a rotation limiting pin 6, a central shaft part 9, a position limit clevis pin 7 and a helical compression spring 8. The gear 2 is fixed at one end of the main drum body 20. The axis of the gear 2 coincides with the axis of the main drum body 20. The gear 2 rotates synchronously with the main drum body 20 around their common axis. The rotational driving force receiver 3 is connected to the regulating slider 4 through the rotation limiting pin 6. The rotational driving force receiver 3 can rotate reciprocally around its axis within a certain angular range relative to the regulating slider 4.

The groove part 5 is a cylinder with a top that has an upper chute penetrating in the radial direction and a bottom that has a lower chute penetrating in the radial direction. A base of the regulating slider 4 can reciprocally slide along the radial direction inside the upper chute relative to the groove part 5. The head of the central shaft part 9 can reciprocally slide along the radial direction inside the lower chute relative to the groove part 5.

The gear 2 includes a positioning seat within its cavity, the positioning seat including a drum shaped hole. The size and shape of the drum shaped hole are substantially identical to those of the cross section of the rod portion on the central shaft part 9. Thus, once assembled, the central shaft part 9 can only move longitudinally within the drum shaped hole of the gear 2.

The helical compression spring 8 is set on the central shaft part 9 prior to assembly with the gear 2. The central shaft part 9 is assembled inside the gear 2 by passing the rod portion through the drum shaped hole in the gear 2 and then inserting the position limit clevis pin 7.

The rotational driving force receiver 3, the regulating slider 4, the rotation limiting pin 6, the groove part 5 and the central shaft part 9 comprise a longitudinal regulating component 11. As can be seen in FIGS. 44A-44D, the longitudinal regulating component 11 can make a limited longitudinal and reciprocally translational movement along the longitudinal direction Z of the gear 2 relative to the gear 2 via the compressed force of the helical compression spring 8, the restoring force after losing the external force from the helical compression spring 8 and the longitudinal position limit from the position limit clevis pin 7.

FIGS. 44A-44D show schematic diagrams of a working process in which a process cartridge assembled the driving component 1 (only the end of the photosensitive drum is shown) is engaged into a printer. The process cartridge is engaged into the printer along the direction Xa perpendicular to the axis of the photosensitive drum. If the driving component 1 initially contacts one of the claws extending from the rotational driving force receiver 3, then the printer's driving shaft 13 will push the rotational driving force receiver 3 to rotate a certain angle around its axis until the printer's driving shaft 13 passes through the section between the claws while pushing the driving component 1 to move overall along the direction Za.

If the driving component 1 initially contacts one of the sections between the claws, then the printer's driving shaft 13 will cause the driving component 1 to move overall along the direction Za without rotating.

The moving displacement of the longitudinal adjustment component 11 in the driving component 1 overall along the direction Za is increased gradually as the printer's driving shaft 13 is being moved in the direction Xa. After the printer's driving shaft 13 contacts the edge of a spherical surface on the receiving face of receiver 3, the longitudinal regulating component 11 in the driving component 1 moves overall along the direction Zb until the top of the printer's driving shaft 13 substantially coincides with the spherical surface.

In another embodiment, as can be seen in FIG. 45, the claws 42 that extend from the rotational driving force receiver 3 are rotatable. Thus, when one of the claws 42 is contacted by the printer's driving shaft 13, the claw 42 rotates (as shown by the arrow in FIG. 45) to provide clearance for the printer's driving shaft 13 to pass over the claw 42 an into a central opening 417 of the driving force receiver 3. After the printer's driving shaft 13 to passes over the claw 42, the claw 42 is returned to its upright position by a spring 44.

When the printer starts, the printer's driving shaft 13 will automatically be coupled with the rotational driving force receiver 3, which receives the rotational driving force from the printer to drive the main drum body 20 of the photosensitive drum to rotate.

### BRIEF SUMMARY

A transmission device receives the rotational driving force from the printer to drive the photosensitive drum to rotate. In the exemplary embodiments described herein, the transmission device includes a gear member, a sleeve positioned within the sleeve, and a transmission unit assembled with the sleeve to contact a driving shaft from the printer. The transmission devices described herein provide greater flexibility for assembling the sleeve, gear member, and transmission unit than conventional transmission devices.

It can be advantageous for the sleeve to be removable from the gear, for example, to allow either component to be repaired or replaced. In certain embodiments discussed below, the sleeve is removably attached to the gear member. For example, the sleeve can be held by a snap fit, friction, an interference fit, or sonic welding.

Additionally, the transmission unit, which is removably assembled with the sleeve, has the freedom to rotate relative to the sleeve and is movable in an axial direction relative to the sleeve. The transmission unit can be assembled with the sleeve before or after the sleeve is assembled with the gear member.

An exemplary transmission unit includes a gear member; a sleeve removably attached to the gear member, the sleeve including a guiding groove; and a transmission unit including a shaft having at least one protrusion extending radially outward from the shaft. The guiding groove is shaped such that the protrusion is moveable within the guiding groove in an axial direction and rotatable relative to the guiding groove.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows schematically a perspective view of an exemplary embodiment of a drum device (unit).

FIG. 2A shows an exploded perspective view of an exemplary embodiment of a transmission device utilized in a drum device.

FIG. 2B shows an exploded perspective view of an exemplary embodiment of a transmission device utilized in a drum device.

FIGS. 3A and 3B each show perspective view of an exemplary embodiment of a holding member utilized in a transmission device.

FIGS. 4A and 4B show partially a perspective view and a top view of an exemplary embodiment of a transmission unit utilized in a transmission device.

FIGS. 5A-5D show different perspective views of an exemplary embodiment of an engagement block of a transmission unit utilized in a transmission device.

FIGS. 6A-6F show an assembly process of an exemplary embodiment of a transmission unit utilized in a transmission device.

FIGS. 7A-7C show partially an exemplary embodiment of a transmission unit utilized in a transmission device.

FIGS. 8A-8D show different perspective views of an exemplary embodiment of an engagement block of a transmission unit utilized in a transmission device.

FIGS. 9A-9C and 10A-10F show an exemplary embodiment of an assembly process of a transmission unit utilized in a transmission device.

FIGS. 11A-11C show different views of an exemplary embodiment of a sleeve utilized in a transmission device for a photosensitive drum.

FIGS. 12A and 12B show an exemplary embodiment of a sleeve utilized in a transmission device for a photosensitive drum.

FIGS. 13A-13D show an exemplary embodiment of a gear member and a sleeve assembled in the gear member utilized in a transmission device.

FIG. 14 shows an exemplary embodiment of a pin utilized in a transmission device for a photosensitive drum.

FIG. 15 shows an exemplary embodiment of an elastic member utilized in a transmission device.

FIGS. 16A-16C show an exemplary embodiment of an assembly process of a transmission device.

FIG. 17 shows an exploded perspective view of an exemplary embodiment of a transmission device.

FIGS. 18A-18D show an exploded perspective view of an exemplary embodiment of a transmission unit and its assembly process.

FIGS. 19A-19D show an exemplary embodiment of a transmission unit and its assembly process.

FIGS. 20A-20D show an exemplary embodiment of an assembly process of a transmission unit with a holding member.

FIGS. 21A-21D show an exemplary embodiment of an assembly process of a transmission device.

FIGS. 22A-22C show an exemplary embodiment of a transmission device and its assembly process.

FIGS. 23A-23D show an exemplary embodiment of a gear member utilized in a transmission device.

FIGS. 24A-24D show an exemplary embodiment of a sleeve utilized in a transmission device.

FIGS. 25A-25C show an exemplary embodiment of an assembly process of a sleeve and transmission unit of a transmission device.

FIGS. 26A-26D show an exemplary embodiment of an assembly process of a sleeve and transmission unit of a transmission device.

FIGS. 27A-27C show an exemplary embodiment of a transmission device and its assembly process.

FIGS. 28A and 28B show an exemplary embodiment of a transmission device and its assembly process.

FIGS. 29A and 29B show an exemplary embodiment of an assembly process of a sleeve and transmission unit of a transmission device.

FIG. 30 shows a cross-sectional view of an exemplary embodiment of a transmission device.

FIG. 31 shows an exemplary embodiment of a gear member utilized in a transmission device.

FIGS. 32A and 32B show an exemplary embodiment of a sleeve utilized in a transmission device.

FIGS. 33A-33C show an exemplary embodiment of a gear member utilized in a transmission device.

FIGS. 34A and 34B show an exemplary embodiment of a sleeve utilized in a transmission device.

FIGS. 35A-35C show an exemplary embodiment of an assembly process of a sleeve and gear member of a transmission device.

FIG. 36 shows an exemplary embodiment of a gear member utilized in a transmission device.

FIG. 37 shows an exemplary embodiment of a sleeve utilized in a transmission device.

FIGS. 38A and 38B show an exemplary embodiment of an assembly process of a sleeve and gear member of a transmission device.

FIGS. 39A-39C show an exemplary embodiment of a sleeve and gear member of a transmission device and an assembly process thereof.

FIG. 40 shows a perspective view illustrating an exemplary embodiment of a photosensitive drum.

FIG. 41 shows a perspective view of the transmission device of the photosensitive drum of FIG. 40.

FIG. 42 shows a cut-away view of the transmission device shown in FIG. 41.

FIG. 43 shows an exploded view of the transmission device shown in FIG. 41.

FIGS. 44A-44D show a process of the photosensitive drum of FIG. 40 being engaged into a printer.

FIG. 45 shows a process of a photosensitive drum being engaged into a printer.

### DETAILED DESCRIPTION OF THE PREFERRED EMBODIMENTS

Referring now to the drawings, wherein like reference numerals designate identical or corresponding parts throughout the several views.

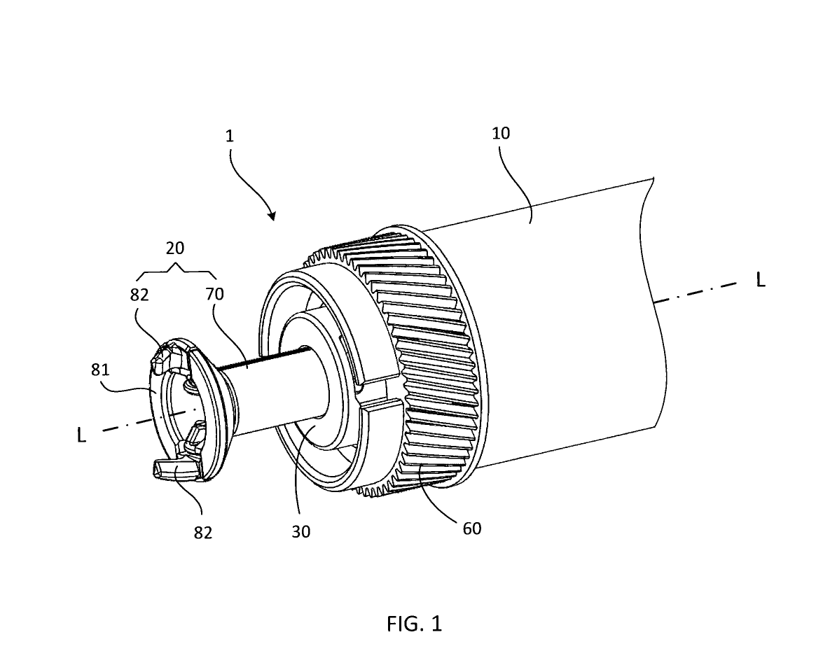

FIG. 1 shows schematically a perspective view of an exemplary embodiment of a drum unit (device), which is described in U.S. patent application Ser. No. 14/617,473, filed Feb. 9, 2015, the entirety of which is incorporated herein by reference. U.S. patent application Ser. Nos. 13/965,856, filed Aug. 13, 2013, 14/310,615, filed Jun. 20, 2014, and 14/461,011, filed Aug. 8, 2014, are also each entirely incorporated herein by reference.

The drum unit includes a photosensitive drum 10 having a drum axis, L, and a driving component (transmission device 1) detachably attached to the photosensitive drum 10 coaxially to the drum axis L. The transmission device 1 is used to receive a rotational driving force from a driving mechanism of an electronic imaging device and transmit the rotational driving force to the photosensitive drum 10. The photosensitive drum 10 in turn rotates around its axis L under the rotational driving force.

In this exemplary embodiment, the transmission device 1 includes a shell 60 detachably attached to one end of the photosensitive drum 10 coaxially to the drum axis L, a sleeve 30 coupled with the shell 60 coaxially to the drum axis L, and a transmission unit 20 disposed to the sleeve coaxially to the drum axis L. In one embodiment, the sleeve 30 is integrally formed with the shell 60 coaxially to the drum axis L. The transmission unit 20 comprises a shaft 70, a base 81, and at least two engagement blocks 82. The shaft 70 is rotatable about the drum axis L relative to the sleeve 30 and movable along the drum axis L relative to the sleeve 30. The base 81 is extended from one end of the shaft 70 integrally. The at least two engagement blocks 82 extend from two opposite sides of the base 81 away from the drum axis L, such that each engagement block 82 is rotatable around a pivotal axis provided at the two opposite sides of the base 81, where the pivotal axis is perpendicular to the drum axis L.

Various embodiments of the transmission device are described in detail as follows.

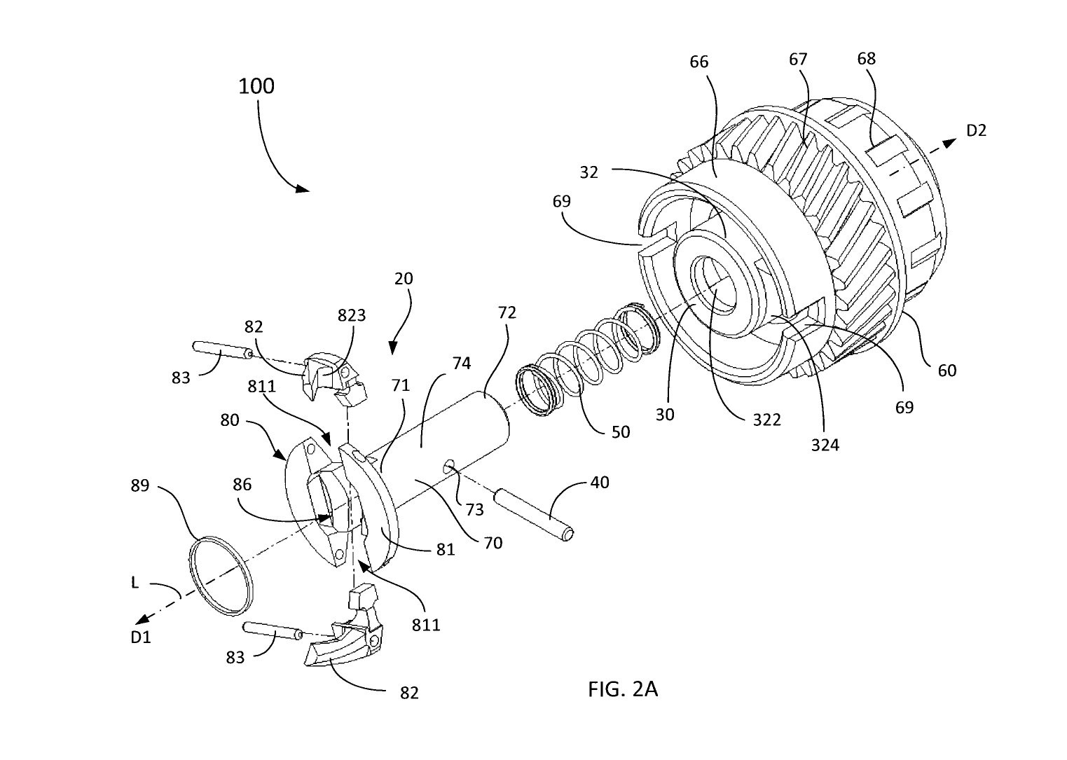

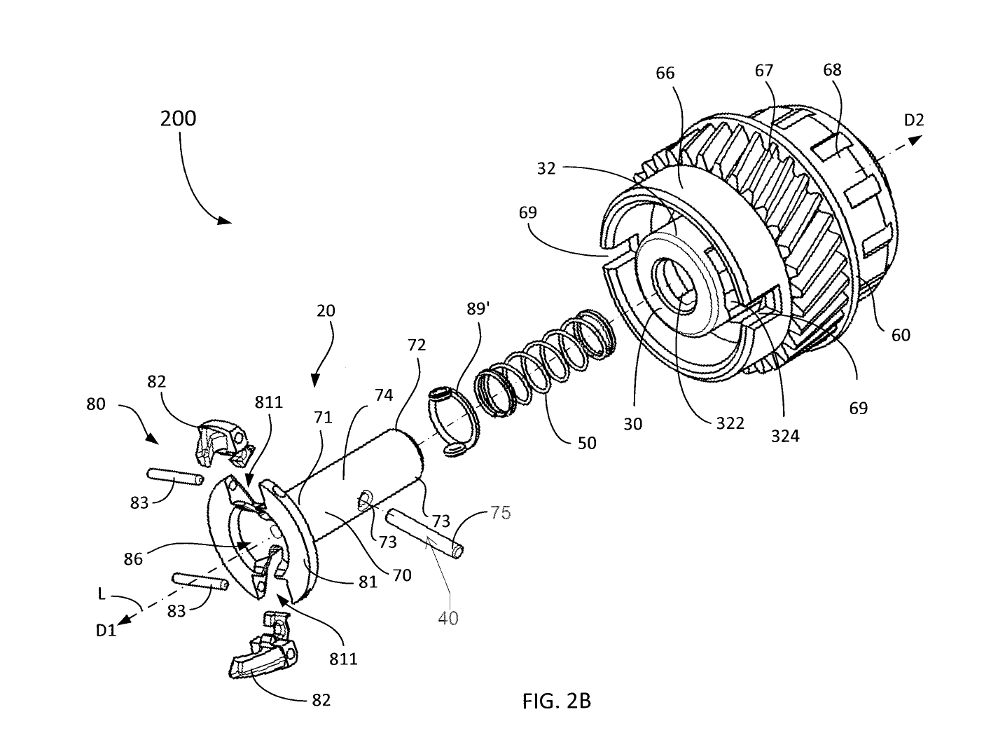

Referring to FIG. 2A, one embodiment of a transmission device 100 comprises a transmission unit 20, a sleeve 30, an elastic member 50, and a gear member (shell) 60. FIG. 2B shows another embodiment of a transmission device 200, which is essentially the same as the transmission device 100 shown in FIG. 2A, except that the elastic holding member 89 utilized in the transmission device 100 is different from that (89′) of the transmission device 200.

As shown in FIGS. 2A, 2B and 4-10, the transmission unit 20 comprises a shaft 70 and an engagement structure 80. The shaft 70 comprises a cylindrical shaft body 74 and at least one protrusion 75 extending along a radial direction of the cylindrical shaft body 74. The shaft body 74 is an elongated element extending along the drum axis L and provided with a first end 71 facing toward a first direction D1, a second end 72 facing toward a second direction D2 opposite to the first direction D1, and an opening 73 penetrating through the main portion of the shaft body 74 along its radial direction. In one embodiment, a pin 40 is inserted into the opening 73 when assembled, where the protrusion 75 is a part of the pin 40 sticking out of the opening 73.

The engagement structure 80 comprises a base 81 extending from the first end 71 of the shaft 70 integrally, and a notched receptacle 811 defined in the base 81. The base 81 has two pairs of holes 812 defined in communication with the notched receptacle 811.

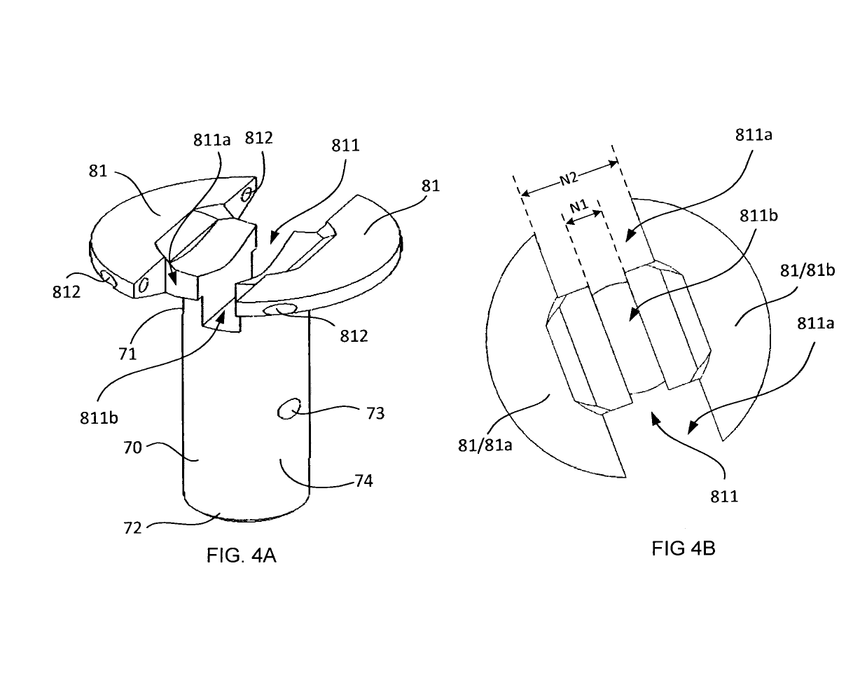

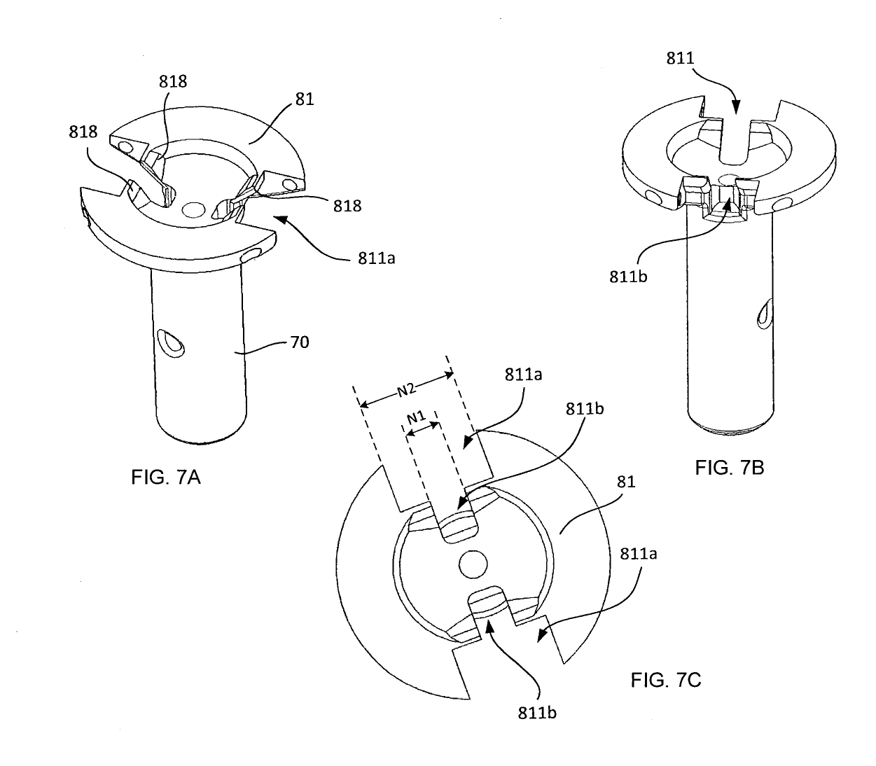

As shown in FIGS. 4A-4B and 7A-7C, the notched receptacle 811 has two openings 811a defined symmetrically in two opposite sides of the base 81, and two grooves 811b, as shown in FIGS. 7A-7C, defined recessively in the base 81 and the first end portion 71 of the shaft 70 and being in communication with the two openings 811a, respectively. Each groove 811b has a width, N1, and each opening 811a has a width, N2, where the width N1 of each groove 811b is narrower than the width N2 of each opening 811a. In one embodiment, as shown in FIGS. 7A-7C, the notched receptacle 811 is defined with barriers 818 that are adapted to prevent an engagement block 82 from over-rotating toward the drum axis L in operation. In addition, the two grooves 811b may be formed in the form of one groove, which separates the base 811 into two portions 81a and 81b, as shown in FIGS. 4A-4B.

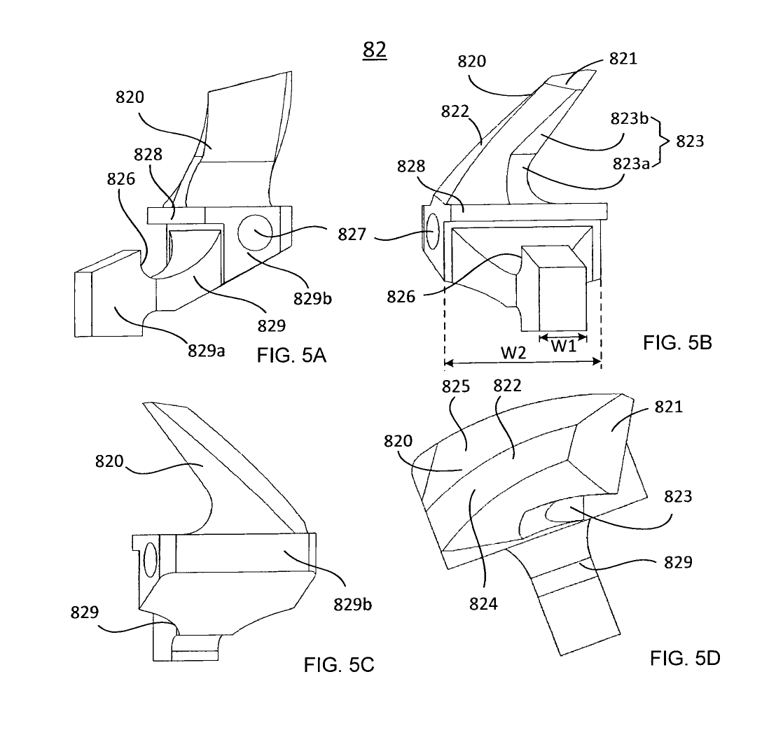

The engagement structure 80 also comprises two engagement blocks 82, as shown in FIGS. 5A-5D. In this exemplary embodiment, the engagement blocks 82 are L-shaped. Other types and shapes of the engagement blocks (for example, straight, U-shaped, C-shaped, J-shaped, etc.) can also be utilized to practice the present invention.

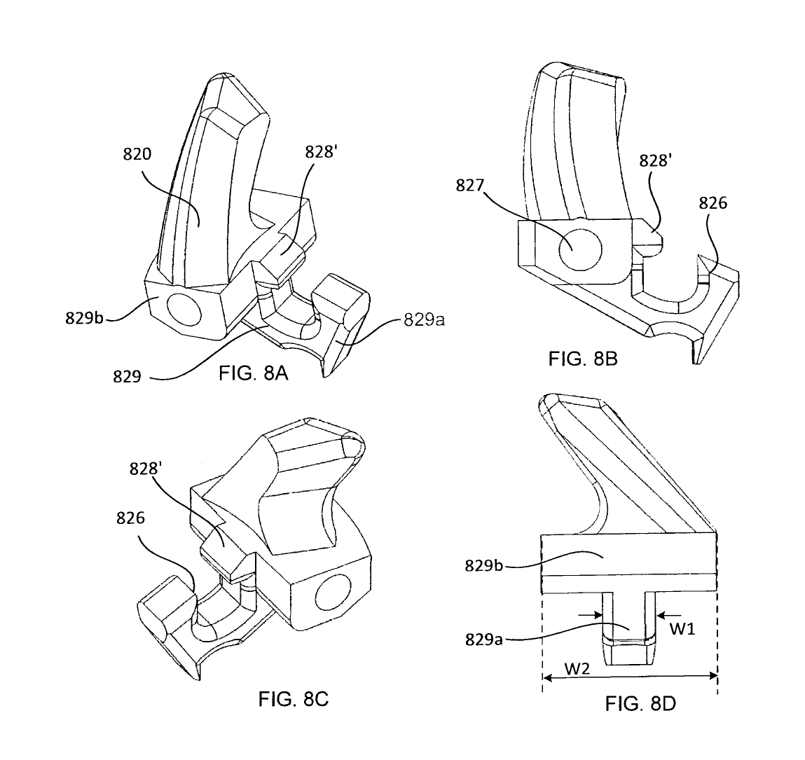

As shown in FIGS. 5A-5D and 8A-8D, each engagement block 82 has a bottom member 829 and an engagement claw 820. The bottom member 829 has a first end portion 829a defining a hook 826 and an opposite, second end portion 829b. The engagement claw 820 extends upwards (or vertically) from the second end portion 829b of the bottom member 829. The two engagement blocks 82 are pivotally received in two opposite sides of the notched receptacle 811, respectively, such that each engagement block 82 is rotatable around a pivotal axis at the second end portion 829b of the bottom member 829, the pivotal axis being perpendicular to the drum axis L, the first end portion 829a of the bottom member 829 is toward the drum axis L and the engagement claw 820 is helically toward the first direction D1 in a normal state. The two engagement blocks 82 define a receiving space 86 therebetween for receiving a drive member (driving mechanism) of an electronic imaging device.

As shown in FIGS. 5A-5D and 8A-8D, each engagement block 82 has an outer surface 825 extending gradually close to the drum axis L toward the first direction D1, an inner surface 824 facing the receiving space 86, an inclined top surface 822 at a junction between the outer surface 825 and the inner surface 824, an engagement concave 823 at another junction between the outer surface 825 and the inner surface 824, and a vertex 821 located between the inclined top surface 822 and the engagement concave 823. The included angle between the extending direction of the inclined top surface 822 and the drum axis L is about 30 to 80 degrees. The engagement concaves 823 of the engagement blocks 82 are opened substantially toward opposite directions for allowing the pillars 92 of the drive member of the electronic imaging device to enter the engagement concaves 823 through openings of the engagement concaves 823. Each engagement concave 823 has an arched recess 823a and a limiting surface 823b located between the recess 823a and the vertex 821 and substantially inclined from the vertex 821 toward the inclined top surface 822. The engagement concaves 823 of the engagement blocks 82 are opened substantially toward opposite directions.

As shown in FIGS. 5A-5D and 8A-8D, the first end portion 829a and the second end portion of the bottom member 829 of each engagement block 82 have a first width, W1, and a second width, W2, respectively. The first width W1 is narrower than the second width W2.

In certain embodiments, the hook 826 of each engagement block 82 is a T-shaped hook. In addition, each engagement block 82 also has a through hole 827 defined in the second portion 829b of the bottom member 829, as shown in FIGS. 5A-5D and 8A-8D. The through hole 827 is coincident with the pivotal axis.

Further, each engagement block 82 has a rotation limiting member 828 formed in the second portion 829b of the bottom member 829 and being toward the first end portion 829a of the bottom member 829. In one embodiment, as shown in FIGS. 5A-5D, the rotation limiting member 828 extends from one side to the other side of the second portion 829b of the bottom member 829, and has the same width (W2) as the second portion 829b of the bottom member 829. However, in another embodiment, as shown in FIGS. 8A-8D, the rotation limiting member 828′ extends from the middle of the second portion 829b of the bottom member 829, and has a width that is essentially the same as that (W1) of the first portion 829a of the bottom member 829, and is narrower than that (W2) of the second portion 829b of the bottom member 829.

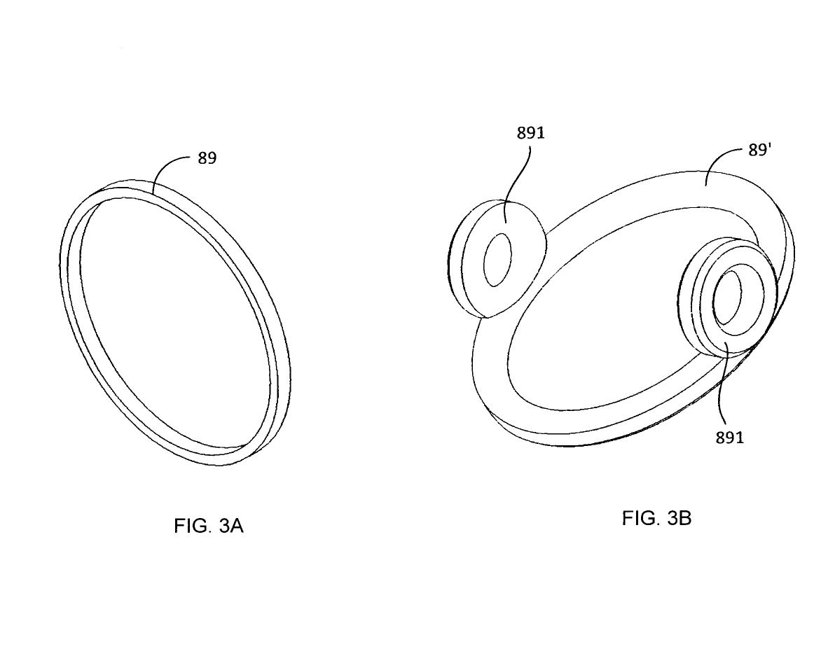

Moreover, the engagement structure 80 also includes a holding member 89 engaged with the hook 826 of the bottom member 829 of each engagement block 82. The holding member 89 can be an elastic ring, a magnet, or a spring. In the embodiment, shown in FIG. 3A, the holding member is an elastic ring 89. The elastic ring 89 may be formed of an elastic material comprising plastic, or silicon. In this exemplary embodiment, the hooks 826 of the bottom members 829 of the two engagement blocks 82 are hooked by the elastic ring 89. In another embodiment, as shown in FIG. 3B, the elastic ring 89′ comprises two ear rings 891 formed on the two opposite sides of the elastic ring 89′. As such, the hooks 826 of the bottom members 829 of the two engagement blocks 82 are hooked by the ear rings 891 of the elastic ring 89′. Alternatively, a spring may be used to connect the hooks 826 of the bottom members 829 of the two engagement blocks 82. In addition, a magnetic force may be utilized to force the two engagement blocks 82 to be in the normal state.

As noted above, other types of the engagement blocks can also be utilized with the transmission units described herein. For example, the engagement claw 820 does not have to be inclined relative to the axial direction. Instead, the engagement claw can be a protrusion extending in the axial direction. The engagement claw can be any shape as long as it can be engaged by a drive member of an electronic image forming apparatus. In another exemplary embodiment, the elastic rings discussed above can be replaced with a tensioning device that is part of the engagement blocks. For example, the pins on which the blocks rotate can include an integral elastic member, such as a spring, that bias the block 82 to return the engagement claws 820 to an upright position. Another exemplary embodiment does not include any elastic ring. Instead, the bottom member 829 of each engagement block 82 protrudes upwards from the notched receptacle 811 such that the drive member of an electronic image forming apparatus contacts the bottom member 829 of each engagement block 82 to return the engagement claws 820 to an upright position.

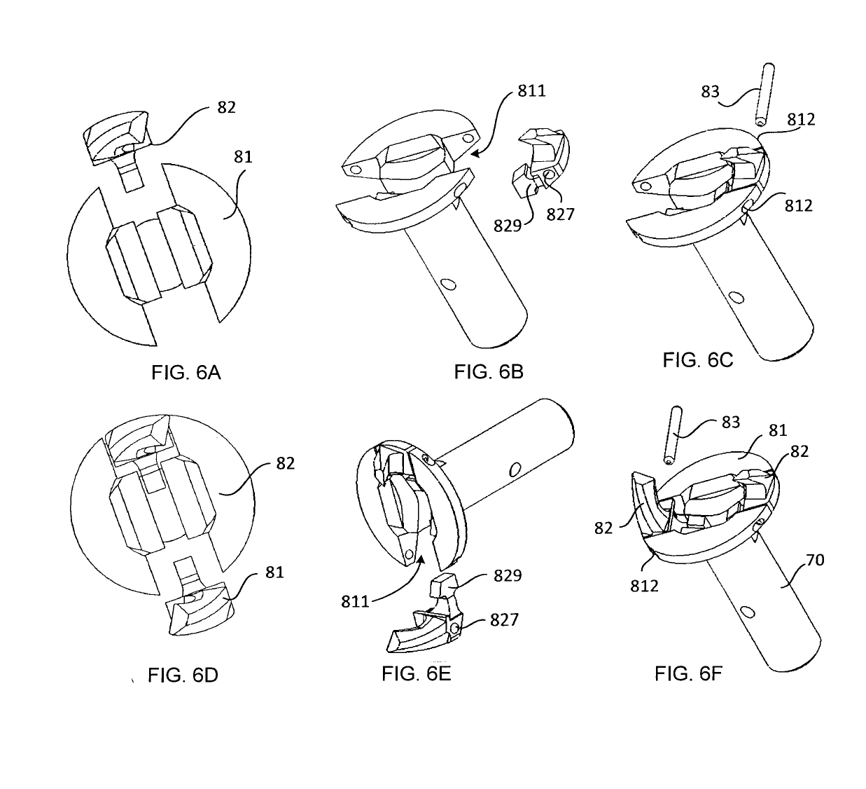

An assembly process of the transmission unit 20 is very simple. As shown in FIGS. 6A-6F, 9A-9C, and 10A-10F, the two engagement blocks 82 are received in the notched receptacle 811 and pivotally secured to the base 81 by two pins 83. For example, each engagement block 82 is placed into a respective opening 811a and groove 811b, a pin 83 is inserted through the through hole 827 of the engagement block 82 and a respective pair of holes 812 of the base 81 to pivotally attach the engagement block 82 to the base 81, and the holding member (elastic ring) 89 is then placed to hook the hooks 826 of the two engagement blocks 82, as shown in FIG. 6A-6F.

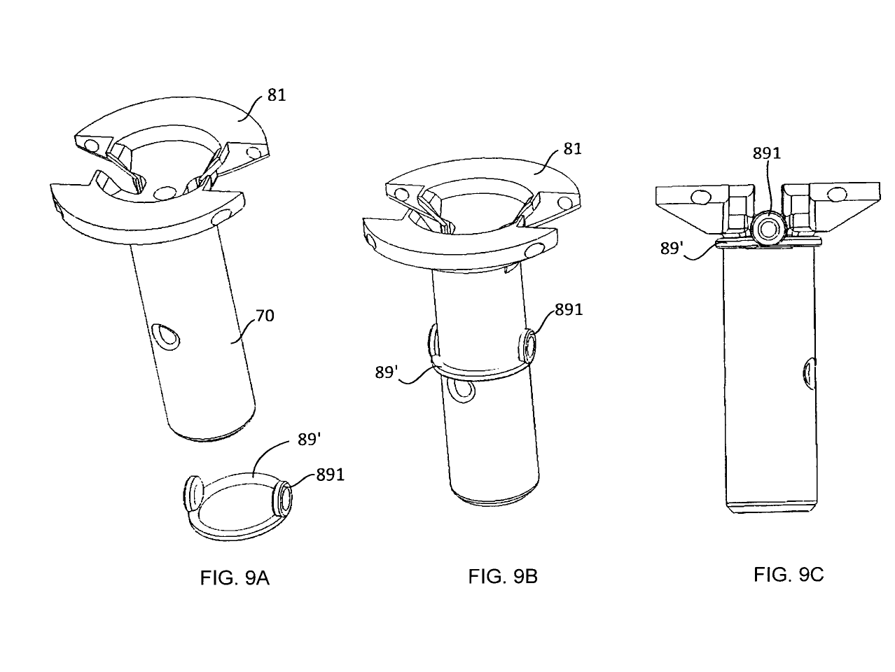

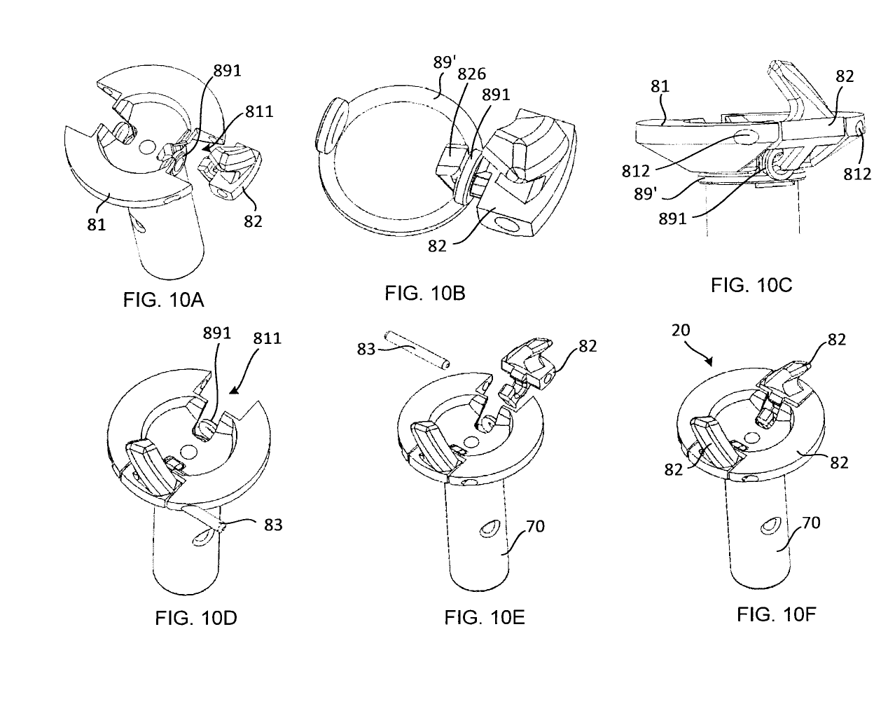

Alternatively, as shown in FIGS. 9A-9C and 10A-10F, first, the shaft 70 is inserted in the elastic ring 89′ to position the ear rings 891 in the grooves 811b. Then, each engagement block 82 is placed into a respective opening 811a and groove 811b, the hooks 826 of the two engagement blocks 82 are inserted into the ear rings 891 of the elastic ring 89′, and a pin 83 is inserted through the through hole 827 of the engagement block 82 and a respective pair of holes 812 of the base 81 to pivotally attach the engagement block 82 to the base 81.

As such, the second end portion 829b of the bottom member 829 of each engagement block 82 is received in the respective opening 811a, the first end portion 829a of the bottom member 829 of each engagement block 82 is received in the respective groove 811b, and each engagement block 82 is rotatable around its pivotal axis, i.e., its corresponding pin 83. The engagement blocks 82 extends helically from two opposite sides of the base 8, respectively, which are about the upside and the downside of the base 81 shown in FIGS. 2A and 2B, away from the drum axis L and toward the first direction D1. The pulling force exerted on the hooks 826 of the two engagement blocks 82 by the elastic ring 89 (or 89′) makes the engagement blocks 82 be positioned with each engagement claw 820 in an upright position as shown in FIGS. 6F and 10F in the normal state.

Furthermore, the transmission device, which comprises a transmission unit 20, also includes a sleeve 30, a gear member 60 and an elastic member 50.

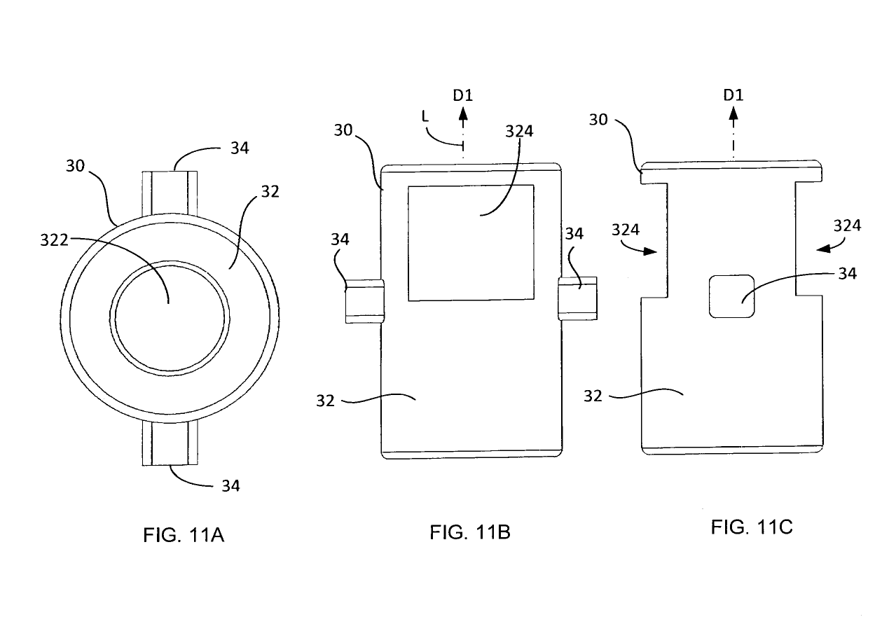

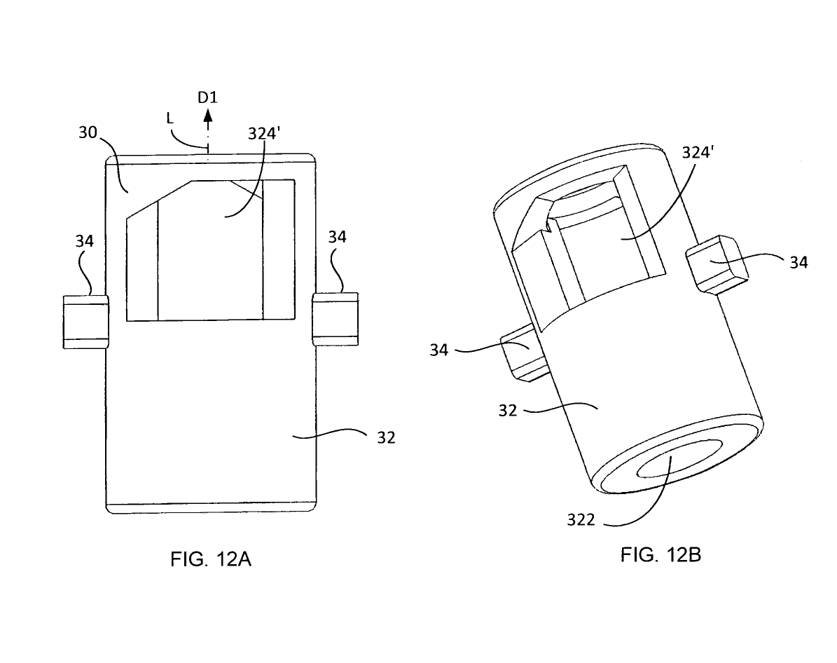

Referring to FIGS. 2A, 2B, 11A-11C, and 12A-12B, and particularly to FIGS. 11A-11C and 12A-12B, the sleeve 30 comprises a main body 32, an axial hole 322 defined through the main body 32 along the drum axis L, two guiding grooves 324 formed on the main body 32, communicated with the axial hole 322, and two pillars 34 protruding from the main body 32. Only one of the guiding grooves 324 is shown in the figures, and the other groove 324 is located opposite to the groove 324 shown in the figures.

In the embodiment shown in FIGS. 11A-11C, each guiding groove 324 is in a shape of rectangle, and has a bottom side substantially perpendicular to the drum axis L, two lateral sides respectively extending from two ends of the bottom side toward to the first direction D1, and a top side connected between the two lateral sides and parallel to the bottom side. In the embodiment shown in FIGS. 12A-12B, the top side has a sloped portion and an extending portion parallel to the bottom side. It should be appreciated to one skilled in the art that other types of the sleeve can also be utilized to practice the invention. For example, other exemplary sleeves can include guiding grooves having different shapes than those shown in FIGS. 11A-11C and 12A-12B, such as a triangle, oval, circle, square, etc. provided that the pin 40 can move within the guiding grooves to allow the transmission unit 20 to move in an axial direction and to rotate. Once the transmission unit 20 is driven by the drive member of an electronic image forming apparatus, the pin 40 will contact an edge of the guiding groove 324 of the sleeve 30 to transmit the rotation to the gear member 60 via the sleeve 30.

As assembled, the shaft 70 of the transmission unit 20 is disposed in the axial hole 322 and capable of rotating about the drum axis L relative to the sleeve 30 and moving along the drum axis L relative to the sleeve 30. The pin 40 is inserted into the opening 73 of the transmission unit 20 in such a way that the shaft 70 of the transmission unit 20 has two protrusions 75 extending along the shaft's radial direction, as shown in FIG. 2B. The protrusions 75, which are formed by the two parts of the pin 40 that protrude out of the opening 73, are movably received in the guiding grooves 324, respectively.

It should be appreciated to one skilled in the art that the opening 73 of the transmission unit 20 can also be provided without penetrating the shaft 70. For example, the shaft 70 of the transmission unit 20 may have only one protrusion 75 and the sleeve 30 only needs to be provided with one guiding groove 324. Besides, the protrusion 75 of the shaft 70 is not limited to be formed by the pin 40 inserted into the opening 73. For example, the protrusion 75 can be integral with the shaft body 74; in that condition, the guiding groove 324 should have an open end so that the protrusion 75 can enter the guiding groove 324 through its open end, and the open end of the guiding groove 324 should be capped by an annular cap provided at, but not limited to, the shaft 70.

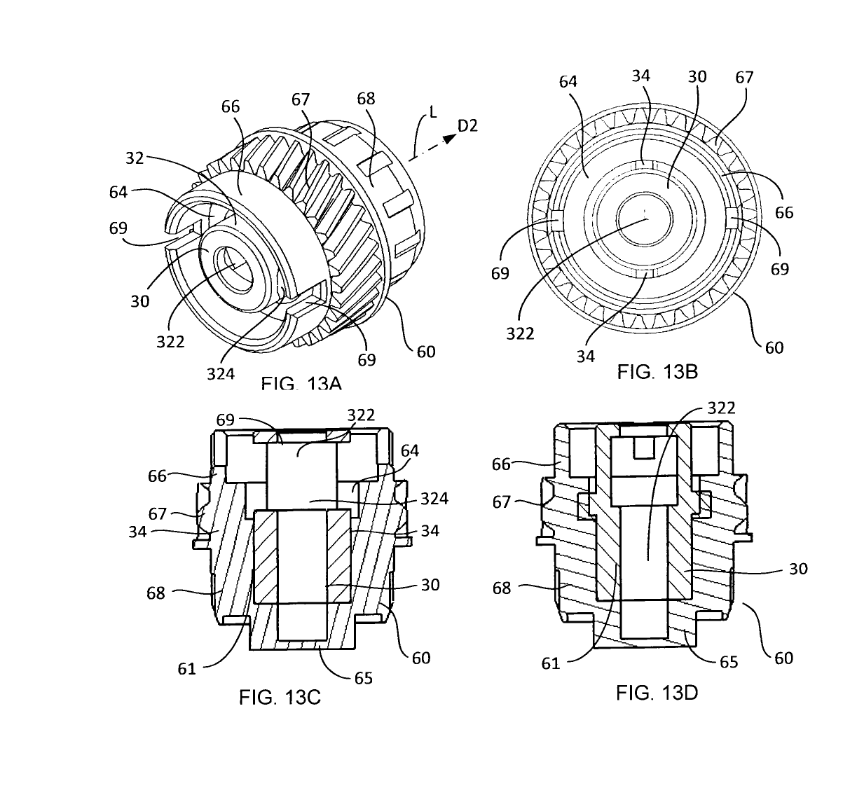

Referring to FIGS. 2A, 2B and 13A-13D, the gear member 60 is adapted for engaging with the photosensitive drum and the gear member 60 has a top portion 66, a gear portion 67 extending from the top portion 66 along the drum axis L toward the second direction D2, a bottom portion 68 extending from the gear portion 67 along the drum axis L toward the second direction D2, a top wall 64 located at the side of the top portion 66, and a bottom wall 65 located at the side of the bottom portion 68. In addition, the top portion 66 of the gear member 60 may have at least one slot 69. The peripheral configuration of the gear member 60 is similar to the conventional ones. Inside the gear member 60, there is a housing 61 defined along the drum axis L for receiving the main body 32 of the sleeve 30 so that the sleeve 30 is coupled with the gear member 60 unrotatably around the drum axis L. In certain embodiments, the sleeve 30 is molded in the gear member 60.

In certain embodiments, the gear member 60 has an installation slot formed on the top wall 64, and two limiting recesses communicated with each other. The housing 61 extends along the drum axis L and opened on the top wall 64. The installation slot extends from the housing 61 toward the two opposite radial directions of the housing 61 and opened on the top wall 64. The limiting recesses are located adjacent to the installation slot, extending parallel to the drum axis L and not opened on the top wall 64. The sleeve 30 may further have two pillars 34 protruding from the main body 32. In assembly, the two pillars 34 of the sleeve 30 are inserted into the housing 61 through the installation slot, and then the sleeve 30 is turned to cause the pillars 34 to enter the limiting recesses so that the sleeve 30 is limited in the gear member 60. The details of such embodiments are disclosed in the pending U.S. patent application Ser. Nos. 14/461,011, 13/965,856 and 14/310,615, which are hereby incorporated herein in their entireties by reference, and not repeated herein.

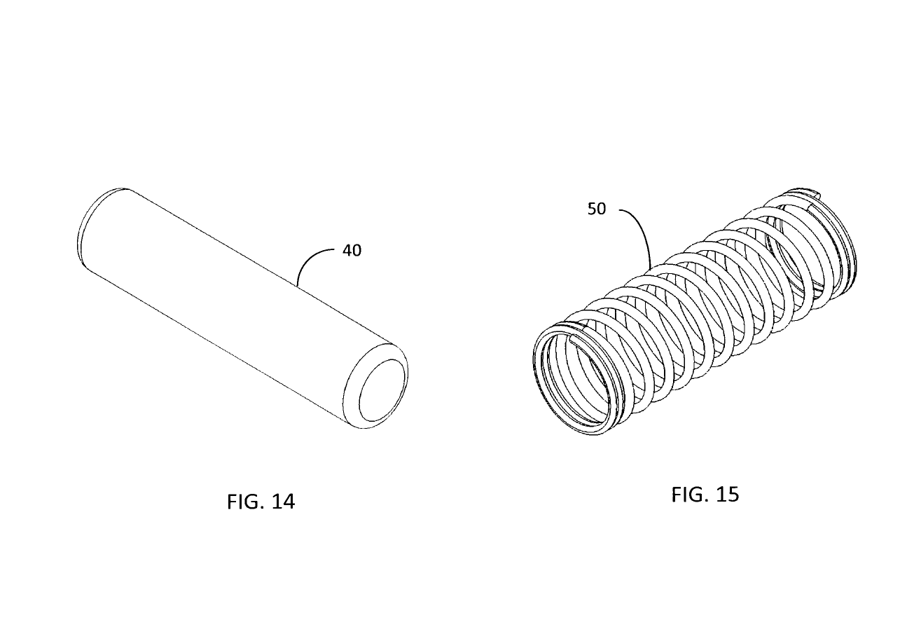

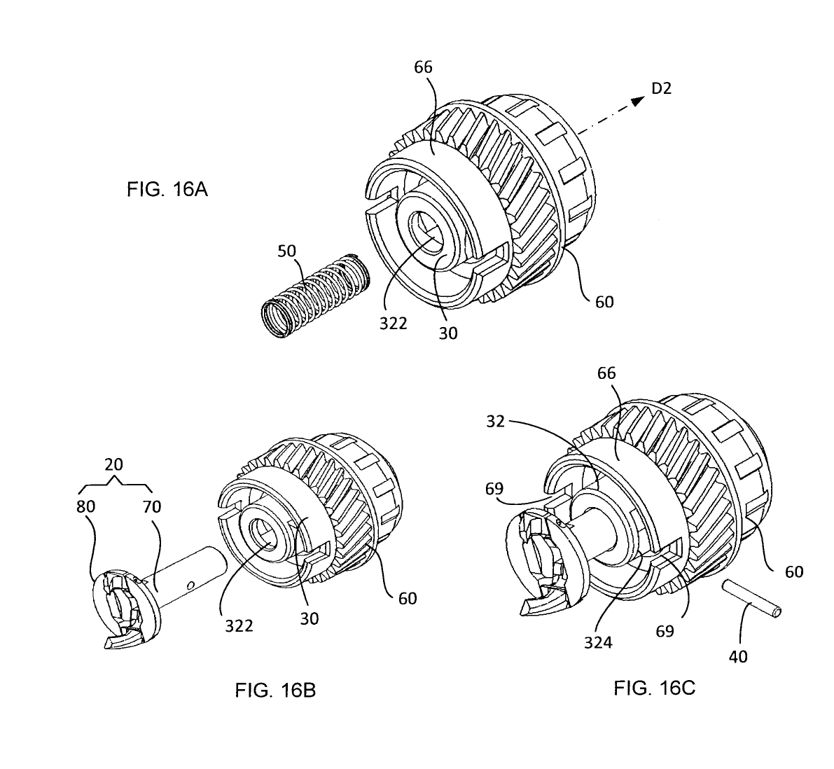

An assembly process of the transmission device is very simple. As shown in FIG. 16A, first, the elastic member 50 is disposed in the axial hole 322 of the sleeve 30. The axial hole 322 of the sleeve 30 is in communication with the housing 61 of the gear member 60. Then, the shaft 70 of the transmission unit 20 is inserted in the axial hole 322 of the sleeve 30, as shown in FIG. 16B. Next, the pin 40 is inserted into the opening 73 of the shaft 70 of the transmission unit 20 through the through slots 69 of the gear member 60 and the guiding grooves 324 of the sleeve 30, as shown in FIG. 16C. As such, the two end portions (i.e., protrusions 75) of the pin 40 are retained and moveably limited in the guiding grooves 324, and two ends of the elastic member 50 are abutted against the bottom wall 65 of the gear member 60 and the second end 72 of the shaft 70 of the transmission unit 20, respectively, so that a force generated by the elastic member 50 exerts on the second end 72 of the shaft 70 of the transmission unit 20 along the drum axis L, which makes the pin 40 (i.e., protrusions 75) of the shaft 70 in a position against the top side or vertex of the guiding grooves 324 of the sleeve 30 in a normal state of the transmission device.

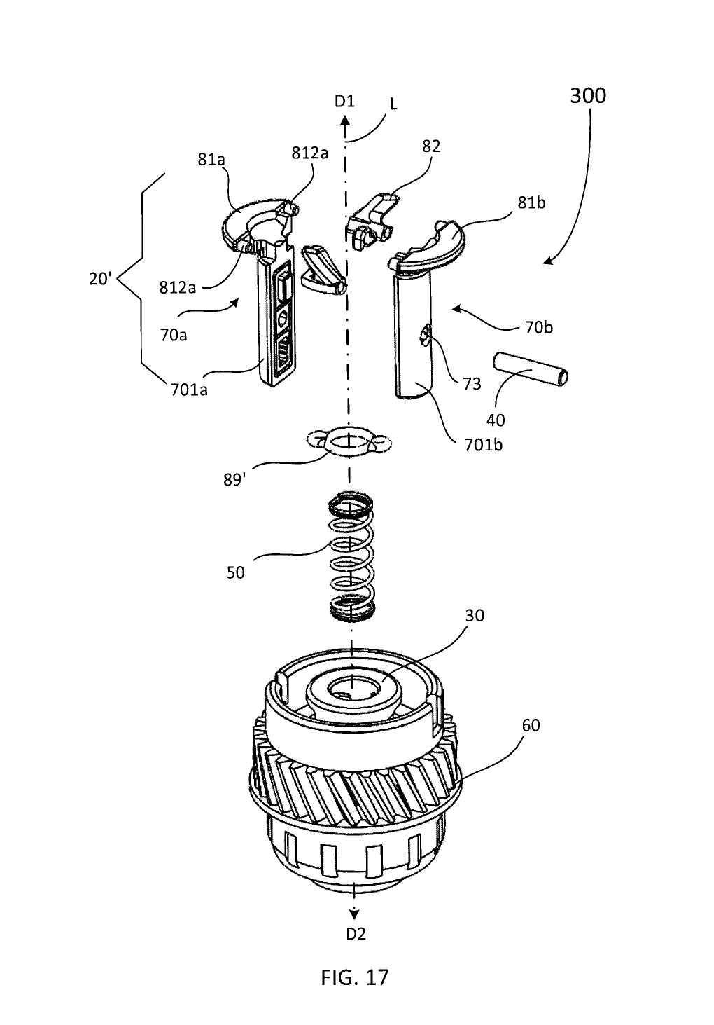

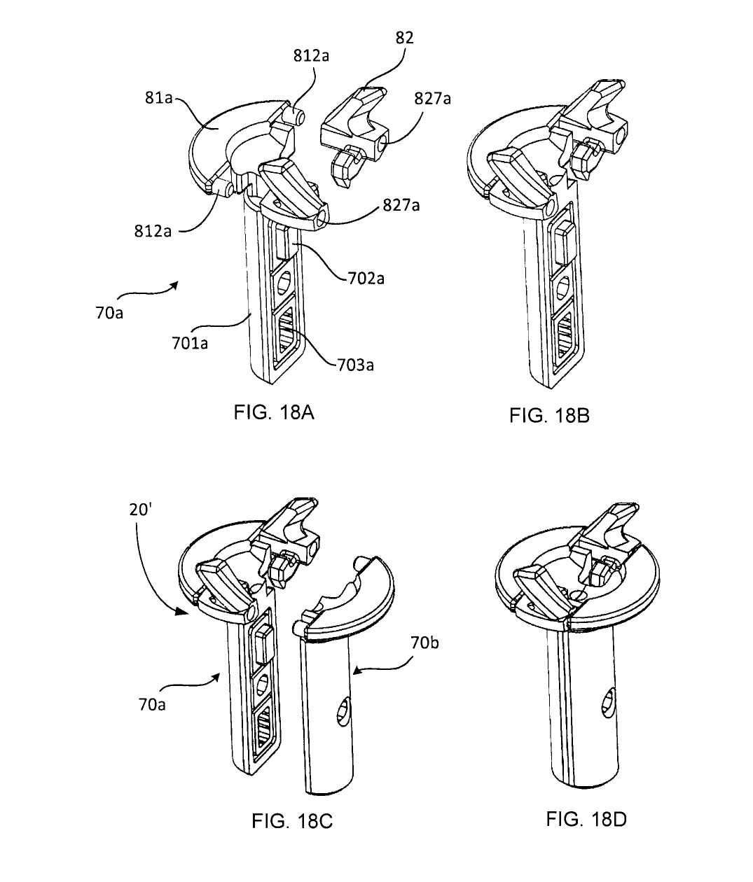

FIG. 17 shows one embodiment of a transmission device 300, which is essentially the same as the transmission device 200 shown in FIG. 2B, except that the transmission unit 20′ utilized in the transmission device 300 is different from that (20) of the transmission device 200. FIGS. 18A-18D show this embodiment of the transmission unit 20′ that includes the shaft, the base, and the two engagement blocks.

Referring to FIGS. 17 and 18A-18D, the shaft 70 in this exemplary embodiment, comprises a first part 70a and a second part 70b, each part 70a/70b comprising a semi-cylindrical body 701a/701b. The base 81 also has two portions 81a and 81b, each base portion 81a/81b extending from one end of the respective semi-cylindrical body 701a/701b. The semi-cylindrical bodies 701a and 701b of the first and second parts 70a and 70b are detachably attachable to each other.

In this embodiment, each semi-cylindrical body 701a/701b has an elongated plane surface parallel to the drum axis L, at least one protrusion 702a protruded from the elongated plane surface, and at least one recess 703a recessed from the elongated plane surface. As such, when assembled, the at least one protrusion 702a of the semi-cylindrical body 701a of the first part 70a is received in the at least one recess 703b of the semi-cylindrical body 701b of the second part 70b, and the at least one protrusion 702b of the semi-cylindrical body 701b of the second part 70b is received in the at least one recess 703a of the semi-cylindrical body 701a of the first part 70a. In other words, the semi-cylindrical bodies 701a and 701b of the first and second parts 70a and 70b of the shaft 70 can be detachably snapped to each other.

In an alternative embodiment, different shapes for the protrusion and recess (for example, circular, triangular, etc.) and/or a different number of protrusions or recesses (one of each, three of each, etc.) can be used to detachably snap fit the semi-cylindrical bodies 701a and 701b of the first and second parts 70a and 70b of the shaft 70. Alternatively, the protrusions and recesses can be sized to detachably couple the semi-cylindrical bodies 701a and 701b through a friction fit.

In this embodiment, the base 81 has two base portions 81a/81b. Each base portion 81a/81b has two pins 812a extending towards the at least two notched receptacles 811, respectively, such that, as assembled, each pin 812a is coincident with the pivotal axis.

In this embodiment, each engagement block 82 is essentially the same as that shown in FIGS. 8A-8D, except that two holes 827a, instead of a through hole, are oppositely defined in the bottom member. As such, when assembled, the pins 812a of the base portions 81a and 81b are received in the two holes 827a of the engagement blocks 82. Accordingly, each engagement block 82 is rotatable around the pivotal axis at the second end portion 829b of the bottom member 829.

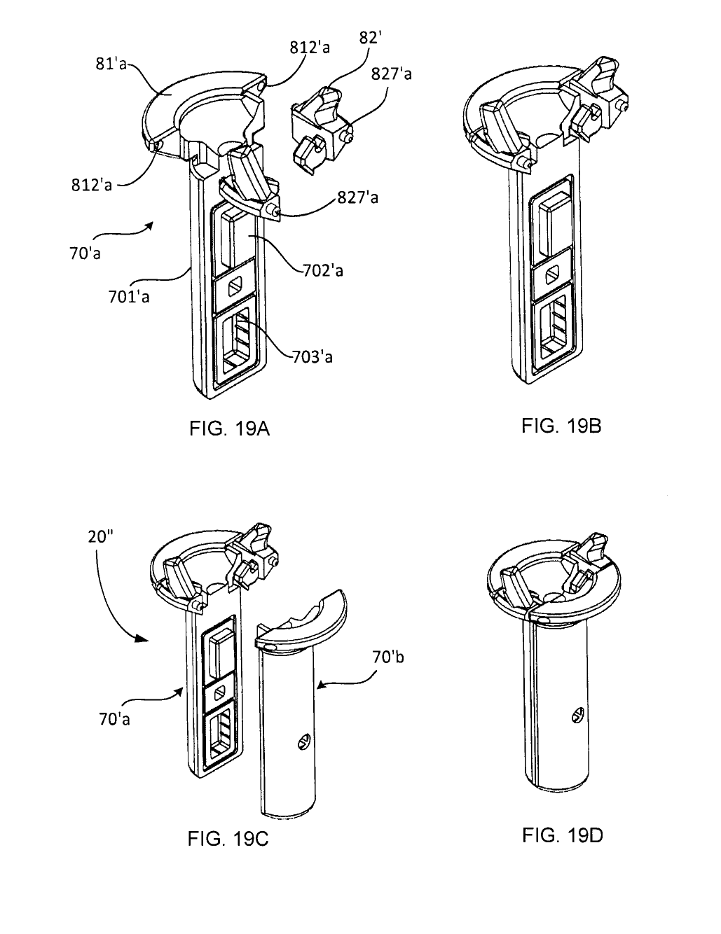

FIGS. 19A-19D shows another embodiment of a transmission unit 20″, which is essentially the same as the transmission unit 20′ shown in FIGS. 18A-18D, except that the base portions and engagement blocks utilized in the transmission unit 20″ are different from that of the transmission unit 20′. In the exemplary embodiment, each base portion 81′a/81′b has two holes 812′a defined facing the at least two notched receptacles 811, respectively, such that, as assembled, each hole 812′a is coincident with the pivotal axis. In addition, each engagement block 82′ has two pins 827′a oppositely protruded from its bottom member. As such, when assembled, the two pins 827′a of each engagement block 82′are received in the corresponding holes 812′a of the base portions 81′a and 81′b. Accordingly, each engagement block 82′ is rotatable around the pivotal axis.

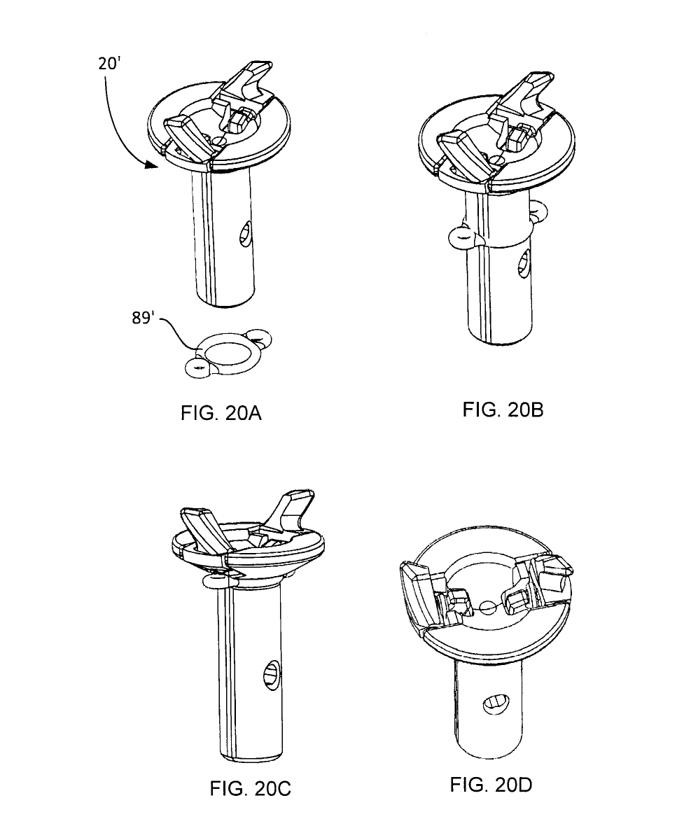

FIGS. 20A-20D show an assembly process of the transmission unit 20′ (or 20″) with a holding member 89′ according to an exemplary embodiment, which is the same as that shown in FIGS. 9A-9C. In this exemplary embodiment, the elastic ring 89′ comprises two ear rings formed on the two opposite sides of the elastic ring 89′. As such, the hooks 826 of the bottom members 829 of the two engagement blocks 82 are hooked by the ear rings 891 of the elastic ring 89′. Alternatively, a spring may be used to connect the hooks 826 of the bottom members 829 of the two engagement blocks 82.

The transmission units 20, 20′, 20″ discussed above each show two engagement blocks 82. In an alternative embodiment, a different number of engagement blocks (for example, one, three, four, etc.) can be used.

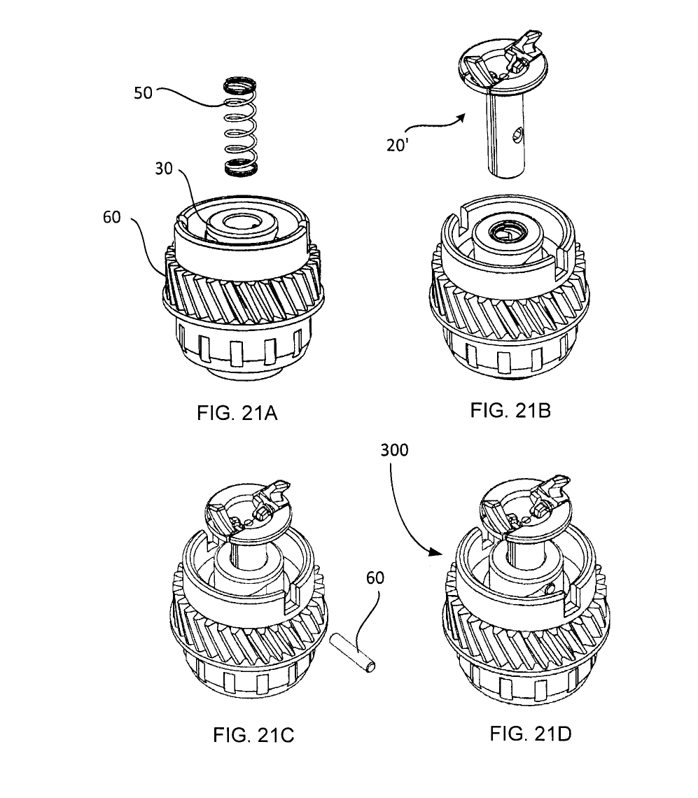

FIGS. 21A-21D show an assembly process of the transmission device 300, which the same as that of the transmission device 100 shown in FIGS. 16A-16C. At first, the elastic member 50 is disposed in the axial hole of the sleeve 30, as shown in FIG. 21A. The axial hole of the sleeve 30 is in communication with the housing of the gear member (shell) 60. Then, the shaft of the transmission unit 20′ is inserted in the axial hole of the sleeve 30, as shown in FIG. 21B. Next, the pin 40 is inserted into the opening of the shaft of the transmission unit 20′ through the through slots of the gear member 60 and the guiding grooves of the sleeve 30, as shown in FIG. 21C. As such, the two end portions (i.e., protrusions) of the pin 40 are retained and moveably limited in the guiding grooves, and two ends of the elastic member 50 are abutted against the bottom wall of the gear member 60 and the second end of the shaft of the transmission unit 20′, respectively, so that a force generated by the elastic member 50 exerts on the second end of the shaft of the transmission unit 20′ along the drum axis L, which makes the pin 40 (i.e., protrusions) of the shaft in a position against the top side or vertex of the guiding grooves of the sleeve 30 in a normal state of the transmission device 300.

In an alternative embodiment, the pin 40 is replaced with a protrusion 75 that is integral with and extends from each semi-cylindrical body 701a/701b. Such a protrusion 75 can be molded with each semi-cylindrical body 701a/701b.

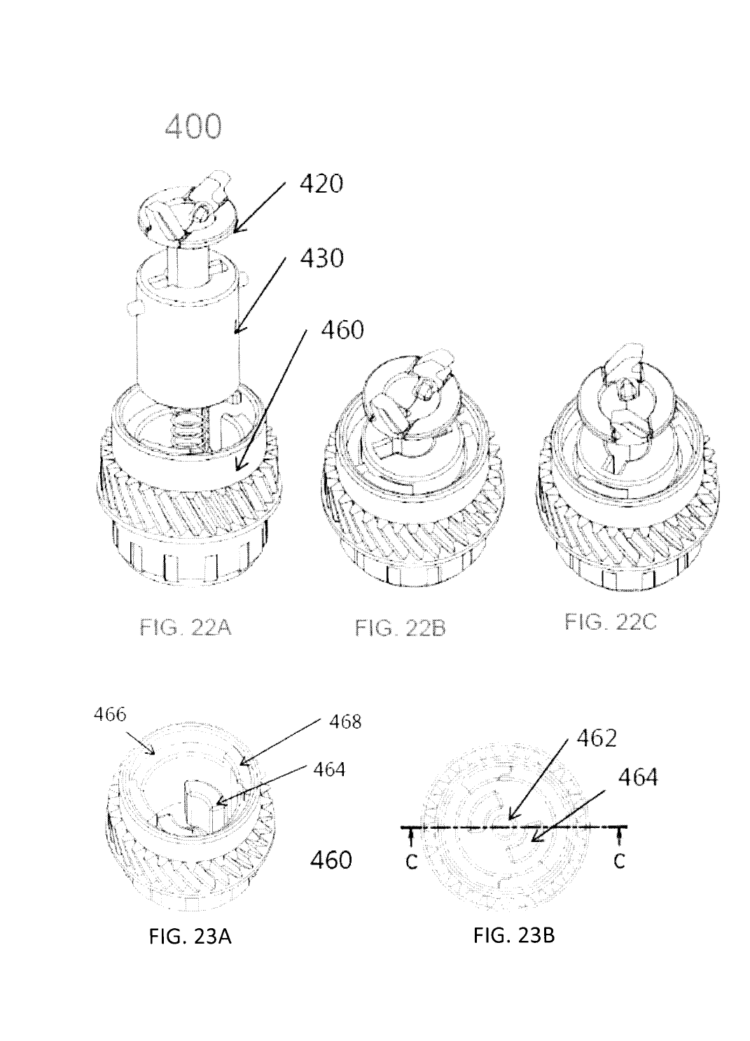

FIGS. 22A-27C show another exemplary embodiment of a transmission device 400. The transmission device 400 includes a gear member (shell) 460, a sleeve 430, and a transmission unit 420. Each of these components is consistent with the exemplary embodiments described above, except where described differently below.

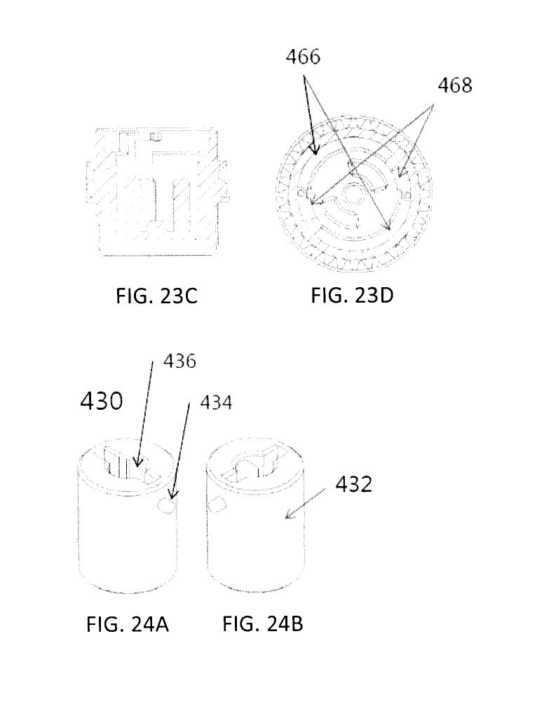

As can be seen in FIGS. 23A-23D, the gear member 460 includes a central projection 462 extending axially upward from a bottom wall of the gear member 460 and at least one peripheral projection 464 positioned radially outside of the central projection 462. The embodiment shown in FIGS. 23A-23D includes two peripheral projections 464. However, a single peripheral projection 464 or three or more peripheral projections 464 can be provided.

The gear member 460 further includes, on an inside surface, a ledge 466 and at least one receiving member 468 positioned on or adjacent to the ledge 466. The ledge 466 can extend continuously around the inside surface of the gear member 460 and have one or more receiving members 468 positioned on the ledge 466. Alternatively, the ledge 466 can include one or more pieces that do not extend continuously around the inside surface of the gear member 460, with one or more receiving members 468 positioned adjacent to the pieces of the ledge 466.

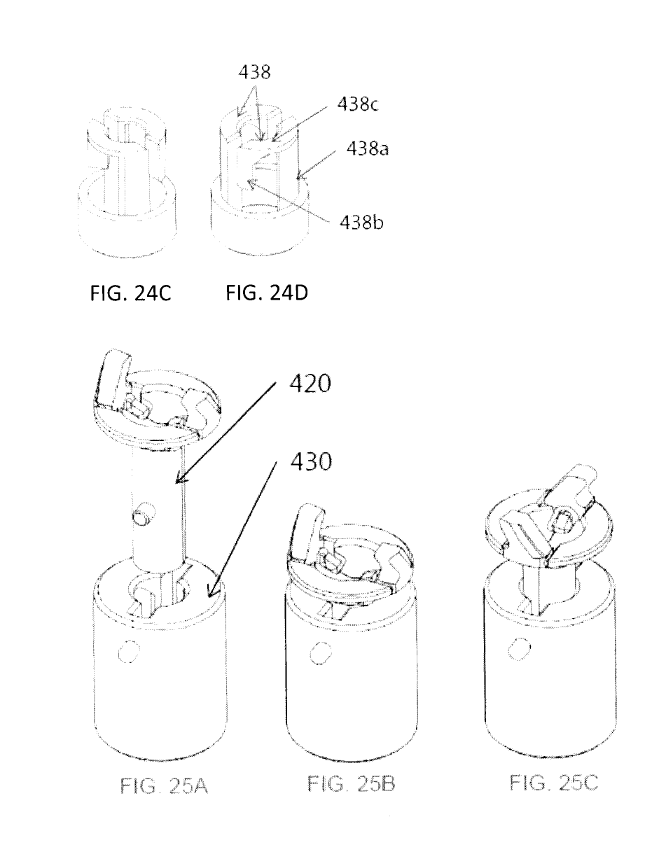

As shown in FIGS. 24A-24D, the sleeve 430 includes a cylindrical body 432 having one or more protrusions 434 extending radially outward from the cylindrical body 432. The sleeve 430 also includes a slot 436 on a top face thereof. In an exemplary embodiment, the slot is sized such that the protrusion in the shaft 70 of the transmission unit 420 can be passed through the slot 436. Thus, a transmission unit with an integral protrusion, such as a molded part of the shaft, instead of the separate pin 40 can be used with the sleeve. In an alternative embodiment, the slot is smaller than the protrusion and thus the protrusion must be inserted into the shaft of the transmission unit after the shaft is positioned within the sleeve.

FIGS. 24C and 24D show the sleeve 430 with part of the cylindrical body 432 and top face removed to expose transmission unit retention members 438 of the sleeve 430. The exemplary embodiment of the sleeve 430 shown includes two of the retention members 438 that are identical to one another and extend axially upward from a bottom of the sleeve 430. Alternatively, the retention members 438 could be formed on or attached to an inside surface of the cylindrical body 432 such that they extend radially inward towards a center of the sleeve 430.

The retention members 438 each include two axial baffles 438a, 438b connected at their top by a connecting piece 438c. One of the axial baffles 438a extends further towards a bottom face of the cylinder 430 than the other of the axial baffles 438b. The retention members 438 are spaced apart from one another to create a gap therebetween.

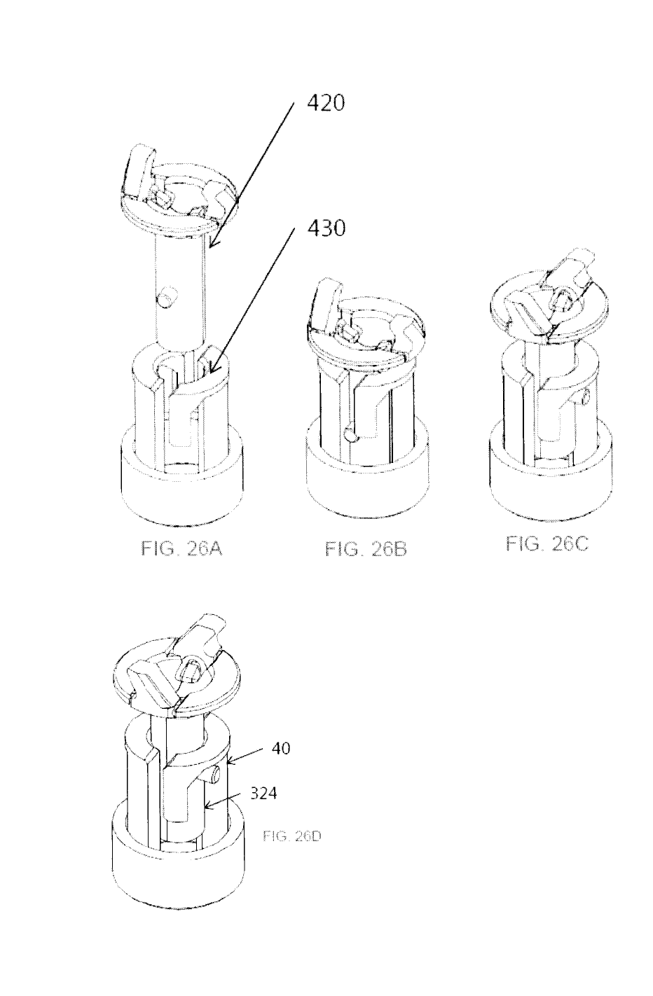

A process of assembling the transmission unit 420 to the sleeve 430 will now be described, and can be seen in FIGS. 25A-25C, which show the sleeve 430 with the entire cylindrical body 432, and FIGS. 26A-26C, which show the sleeve 430 with part of the cylindrical body 432 removed. The transmission unit 420 is similar to the two-piece transmission unit 20′ described above. However, alternative transmission units could be used with the sleeve 430 and gear member 460. For example, the number and shape of the engagement blocks 82 can be changed, as described in the present application.

The shaft 70 of the transmission unit 420 is aligned with and inserted axially into slot 436 in the top face of the sleeve 430 such that the pin 40 passes through the slot 436. As the transmission unit 420 is moved further into the sleeve 430 in the axial direction, the pin 40 is bound by the axial baffles 438a, 438b of each retention member 438 such that these baffles 438a, 438b prevent the transmission unit 420 from rotating with respect to the sleeve 430.

The transmission unit 420 is eventually moved far enough in the axial direction that the pin 40 passes a bottom of the shorter axial baffles 438b. At this point, the transmission unit 420 can be rotated with respect to the sleeve 430. The rotation of the transmission unit 420 is in a counterclockwise direction in the exemplary embodiment shown in FIGS. 25A-25C and FIGS. 26A-26C. However, the rotation would be clockwise in an exemplary embodiment with the position of the axial baffles 438a, 438b were reversed.

After the pin 40 is rotated past the bottom of the shorter axial baffles 438b, the pin 40 enters the area called the guiding groove 324 above. As shown in FIG. 26D, the guiding groove 324 of the sleeve 430 is different than those described above because it is partially open such that the pin can be attached to (or an integral part of) the transmission unit 420 before the transmission unit 420 is inserted into the sleeve 430. Even though the guiding groove 324 is partially open, as will be discussed further below, the transmission unit 420 is biased in the axial direction by an elastic member 50, such as a spring, to keep the pin 40 in the guiding groove 324.

As can be seen in FIG. 26D, the guiding groove 324 formed by each retention member 438 has a shape similar to that of the embodiment shown in FIG. 12. Specifically, the shape of the guiding groove 324 is a rectangle except the top side has a sloped portion and an extending portion parallel to the bottom side, and the left side has an opening due to the shorter axial baffle 438b not extending to the bottom of the rectangle. The guiding groove 324 formed by each retention member 438 can have an alternative shape, such as a rectangle, square, oval, circle, triangle, etc., provided that the shape has an opening to allow the pin to enter the guiding groove 324 and the guiding groove 324 retains the pin 40 while the transmission unit 420 is free to move in an axial direction and to rotate.

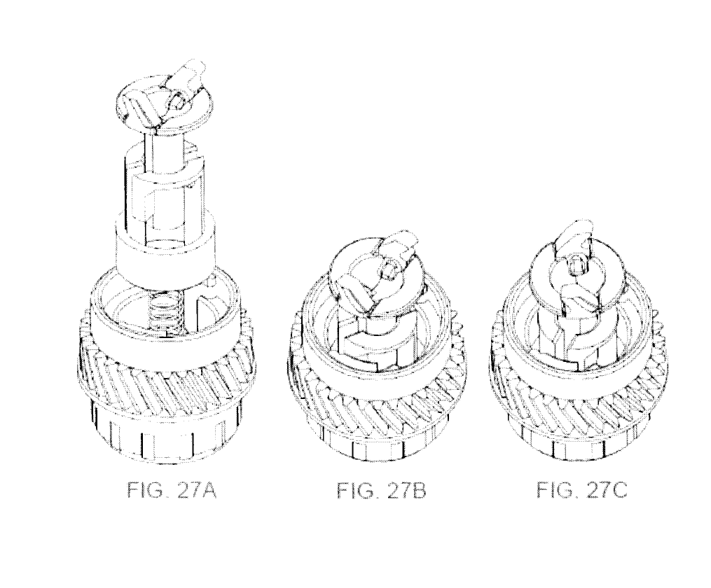

The process for assembling the sleeve 430 to the gear member 460 will now be described. The sleeve 430 can be assembled to the gear member 460 with or without the transmission unit 420 already assembled to the sleeve 430. FIGS. 22A-22C show the sleeve 430 being assembled to the gear member 460 after the transmission unit 420 is assembled to the sleeve 430. FIGS. 27A-27C show the same assembly process as FIGS. 22A-22C, but with part of the cylindrical body 432 removed.

An elastic member 50 is inserted into the gear member 460 and held in place between the central projection 462 and peripheral projections 464. Next, the sleeve 430 is inserted axially into the gear member 460 until the protrusions 434, which extend radially outward from the cylindrical body 432 of the sleeve 430, contact the ledge 466 of the gear member 460, as can be seen in FIG. 22B. Then, as shown in FIG. 22C, the sleeve 430 is rotated until the protrusions 434 contact the receiving members 468. The receiving members 468 can each include an opening facing the ledge 466 such that the protrusions 434 are snap fit into the openings by the rotation of the sleeve 430. This snap fit prevents the protrusions 434 from backing out of the receiving members 468 unless a force sufficient to overcome the snap fit is applied. Alternatively, the openings can retain the protrusions 434 by friction or the protrusions can be free to move in and out of the openings without resistance from the openings.

Once the protrusions 434 are received by the receiving members 468, the gear member 460 is assembled with the sleeve 430. As noted above, the transmission unit 420 can be assembled with the sleeve 430 before the sleeve 430 is assembled with the gear member 460. In such a case, as the sleeve 430 is inserted axially into the gear member 460, the elastic member 50 passes through an opening in the bottom of the sleeve 430 and contacts the shaft 70 of the transmission unit 420 to bias the transmission unit 420 away from the bottom of the sleeve 430. Thus, the pin 40 in the shaft 70 can be biased towards a top side of the guiding groove 324 and away from the opening in the guiding groove 324, thereby maintaining the pin 40 in the guiding groove 324. Thus, the transmission unit 420 remains assembled with the sleeve 430.

To remove the transmission unit 420 from the sleeve 430, an axial force is applied to the transmission unit 420 sufficient to overcome the biasing force applied by the spring 50 to thereby move the transmission unit 420 axially towards the bottom of the sleeve 430. Then, the transmission unit 420 is rotated such that the pin 40 passes below the bottom of the shorter axial baffles 438b. After the pin 40 passes below the bottom of the shorter axial baffles 438b, the transmission unit 420 is free to be separated from the sleeve 430 by moving the transmission unit 420 axially away from the bottom of the sleeve 430 while the pin 40 passes through the gap between the retention members 438 and out of the slot 436.

If the sleeve 430 is not assembled with the transmission unit 420 until after the sleeve 430 is assembled with the gear member 460, then the sleeve 430 is assembled to the transmission unit 420 as described above, except that the spring 50 will provide a biasing force that must be overcome in order to move the transmission unit 420 axially towards the bottom of the sleeve 430 and then rotate the transmission unit 420 such that the pin 40 passes below the bottom of the shorter axial baffles 438b to enter the guiding groove 324.

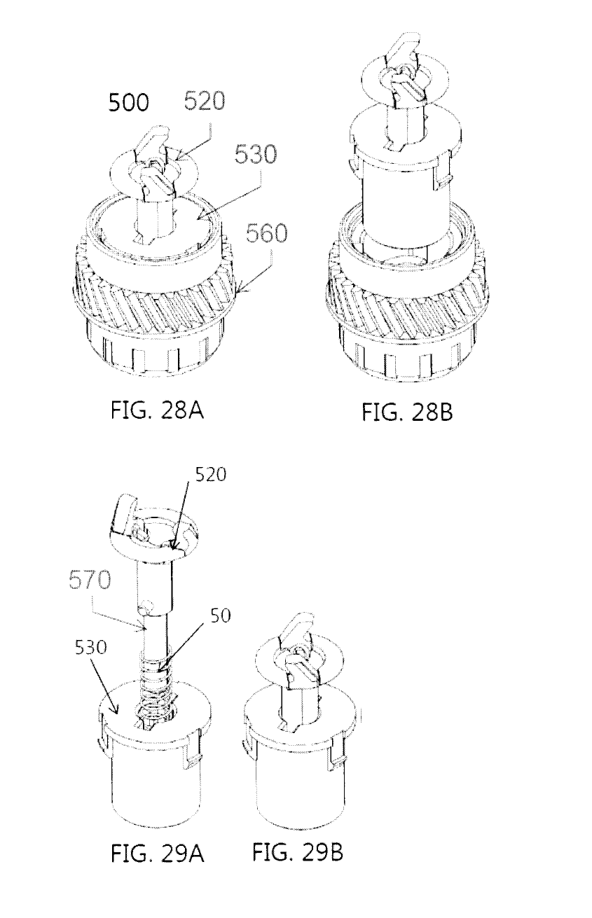

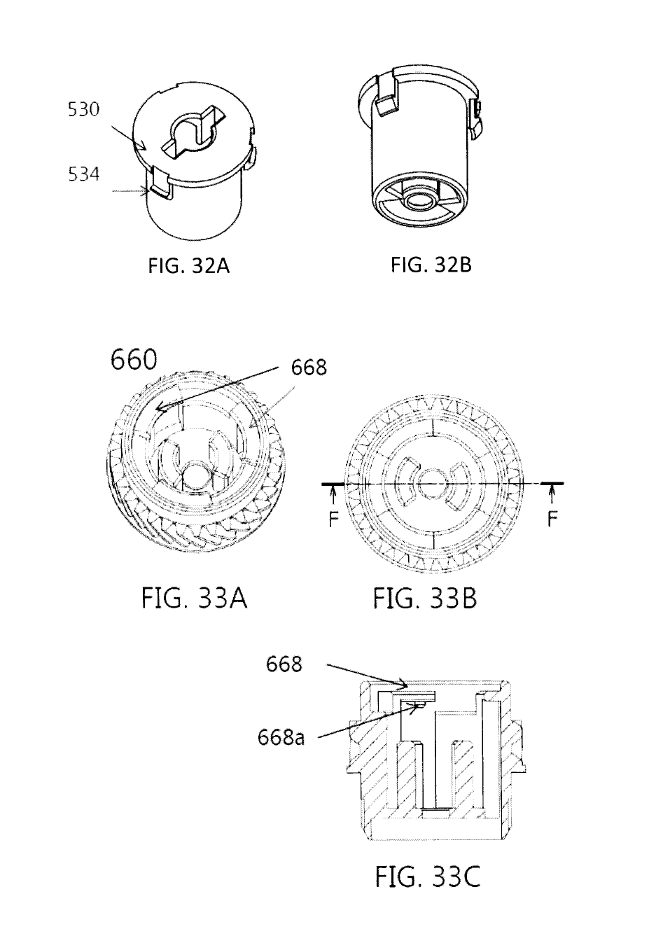

Another exemplary embodiment of a transmission device is shown as reference character 500 in FIGS. 28A-32B. The transmission device 500 includes a gear member (shell) 560, a sleeve 530, and a transmission unit 520. Each of these components is as described above for the transmission device 400, except for the differences described below.

As shown in FIG. 31, the gear member 560 includes a recession 562 that replaces the central projection 462 at a center of its bottom face. Additionally, the one or more receiving members 468 are replaced by one or more receiving members 568 that, instead of receiving and retaining protrusions 434 of the sleeve 430, receiving and retrain clips 534 of the sleeve 530, as discussed further below.

The exemplary embodiment of the gear member 560 shown in FIG. 31 includes three receiving members 568 that are separated by three ledges 466. However, the gear member 560 can include one, two, four, or more receiving members 568. Preferably, the number of receiving members 568 is the same as the number of clips 534 of the sleeve 530.

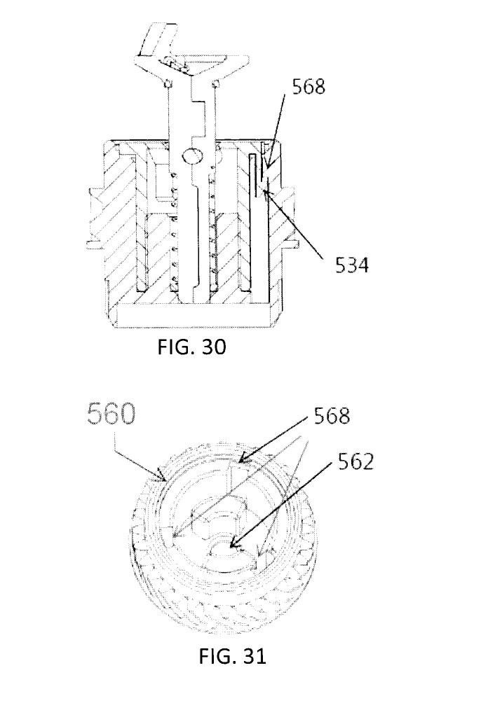

As noted above, the sleeve 530 includes clips 534 that replace the protrusions 434. Thus, as shown in FIGS. 28A and 28B, the sleeve 530 can be assembled with the gear member 560 by aligning the clips 534 with the receiving members 568, and then pressing the sleeve 530 into the gear member 560 in an axial direction. Initially, the clips 568 will contact the receiving members 568 and be deflected radially inwards to allow the sleeve 530 to continue to be pressed into the gear member 560. Once the sleeve 530 has traveled a sufficient distance in the axial direction, the clips 534 pass the receiving members 568 and then elastically return to their original position. As can be seen in FIG. 30, in the assembled position, each clip 534 includes a ledge that, if a user attempts to separate the sleeve 530 from the gear member 560, would contact the receiving member 568, thereby preventing the sleeve 530 from being removed from the gear member 560. Thus, instead of being inserted axially and then rotated, the sleeve 530 is assembled with the gear member 560 by rotating the sleeve 530 until the clips 534 are aligned with the receiving members 568 and then moving the sleeve 530 in an axial direction until the clips 534 pass the receiving members 568.

In an alternative embodiment, the receiving members are elongated in the axial direction such that, even when the sleeve 530 is fully inserted into the gear member 560, the clips 534 contact the receiving members 568. Thus, the clips 534 remain deflected and the friction generated from the contact between the clips 534 the receiving members 568 holds the sleeve 530 in the gear member 560.

The transmission unit 520 shown in FIG. 29A with the sleeve 530 and the gear member 560 is similar to the transmission unit 420, except that the shaft 70 includes a portion 570 having a reduced diameter. To assemble the sleeve 530 and transmission unit 520, the elastic member 50 is placed around the reduced diameter portion 570 of the shaft 70. Then, the shaft 70 of the transmission unit 520 is inserted into the slot 436 and moved in an axial direction and then rotated, as described above for the transmission unit 420. Thus, the elastic member 50 is positioned within the sleeve 530, as can be understood from FIGS. 29A and 30. The elastic member contacts a bottom of the sleeve 530 to provide a biasing force against the transmission unit 520.

When the transmission unit 520 is moved in the axial direction, the recession 562 in the gear member 560 provides extra room to allow the shaft 70 to travel in the axial direction. Alternatively, the recession 562 can be replaced with a hole to allow the end of the shaft to pass through the gear member 560.

Similar to the transmission device 400, the sleeve 530 can be assembled with the transmission unit 520 before or after the sleeve 530 is assembled with the gear member 560.

In another exemplary embodiment of the transmission device 500, the gear member 560 can be replaced with gear member 660 and sleeve 530 can be replaced with sleeve 630, as shown in FIGS. 33A-35C. The gear member 660 is the same as gear member 560 and the sleeve 630 is the same as sleeve 530, except for the differences described below.

As can be seen in FIGS. 33A-33C, the gear member 660 includes receiving members 668 that replace the receiving members 568 described above. Each receiving member 668 includes a projection 668a extending from a bottom face of the receiving member 668.

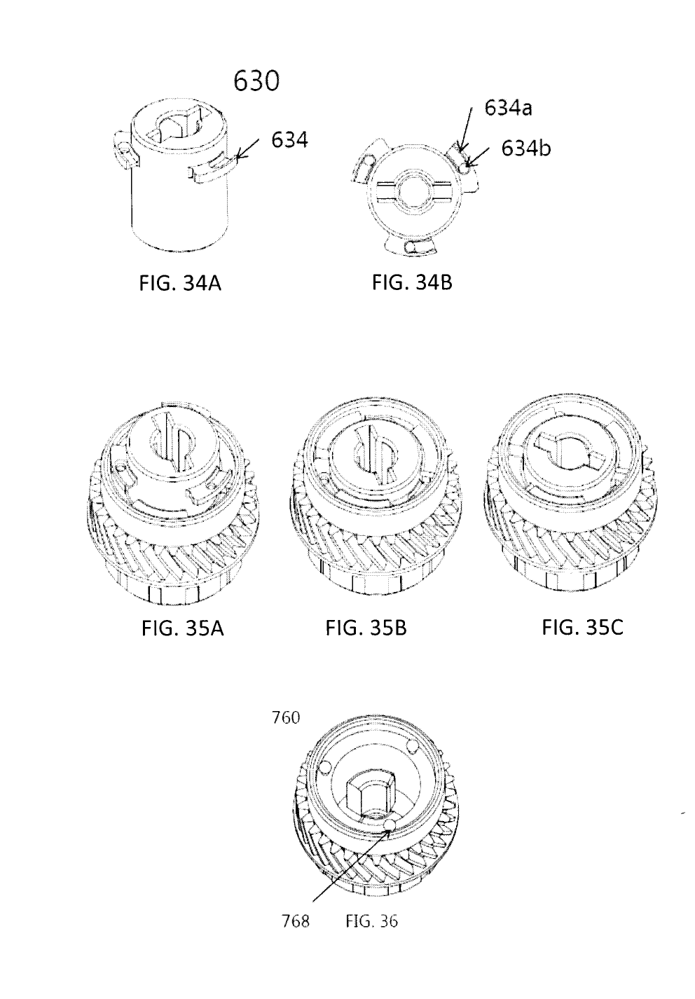

As can be seen in FIGS. 34A and 34B, the sleeve 630 includes protrusions 634 extending radially outward from the cylindrical body. Each protrusion 634 includes a groove 634a that is recessed from a top face of the protrusion. The groove 634a extends from one edge of the protrusion 634 and terminates in a depression 634b that is recessed further from the top face of the protrusion 634 than the groove. Alternatively, the depression 634b could be replaced with a through hole.

As can be understood from FIGS. 35A-35C, the sleeve 630 is assembled with the gear member 660 by aligning the protrusions 634 such that the sleeve 630 can be axially inserted into the gear member 660 and the protrusions 634 will pass between adjacent receiving members 668 until the protrusions 634 contact the ledges 466. After the protrusions 634 contact the ledges 466, the sleeve 630 is rotated with respect to the gear member 660 in a first direction (counterclockwise from FIG. 35B to FIG. 35C) such that each protrusion 634 passes underneath the corresponding receiving member 668. As the sleeve 630 is rotated, the projections 668a will travel within the grooves 634b. In an exemplary embodiment, the projections 668a contact the grooves 634b as the sleeve 630 is rotated.

As the sleeve 630 is further rotated, the projections 668a will enter the depressions 634b, which will retain the projections 668a therein via a snap fit, friction, or an interference fit. In an exemplary embodiment in which an elastic member 50 is positioned between the sleeve 630 and gear member 660, the elastic member will bias the projections 668a into the depressions 634b to help maintain the projections 668a within the depressions 634b.

In another exemplary embodiment of the transmission device 500, the gear member 560 can be replaced with gear member 760 and sleeve 530 can be replaced with sleeve 730, as shown in FIGS. 36-38B. The gear member 760 is the same as gear member 560 and the sleeve 730 is the same as sleeve 530, except for the differences described below.

As can be seen in FIG. 36, the gear member 760 includes receiving members 768 that replace the receiving members 568 described above. Each receiving member 768 is a projection extending from a top face of the ledge 466. In the exemplary embodiment, the receiving member 768 is a spherical member positioned on a shaft extending from the ledge 466. However, other shapes can also be utilized.

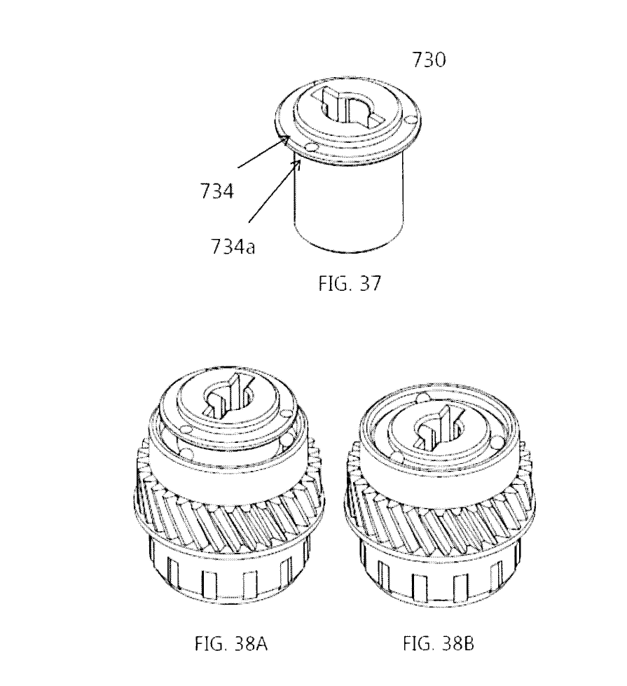

As can be seen in FIG. 37, the sleeve 730 includes a protrusion 734 extending radially outward from the cylindrical body. The exemplary embodiment shown includes a single protrusion that extends continuously around the circumference of the cylindrical body. Alternatively, one or more protrusions that do not extend continuously around the circumference can be used. The protrusion 734 includes a plurality of openings 734a.

As can be understood from FIGS. 38A and 38B, the sleeve 730 is assembled with the gear member 760 by aligning the openings 734a with the receiving members 768 and then pressing the sleeve 730 in the axial direction onto the gear member 760 such that the receiving members 768 pass through the openings 734a. The openings 734a can have a slightly smaller diameter than the receiving members 768 such that the sleeve 730 is snap fit onto the gear member 760.

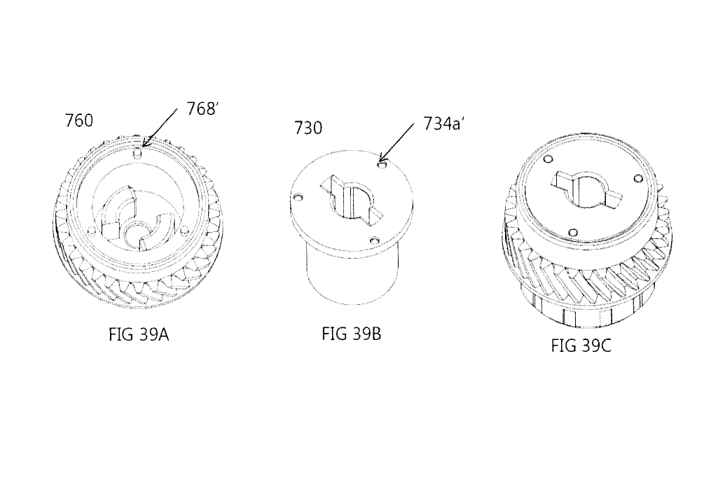

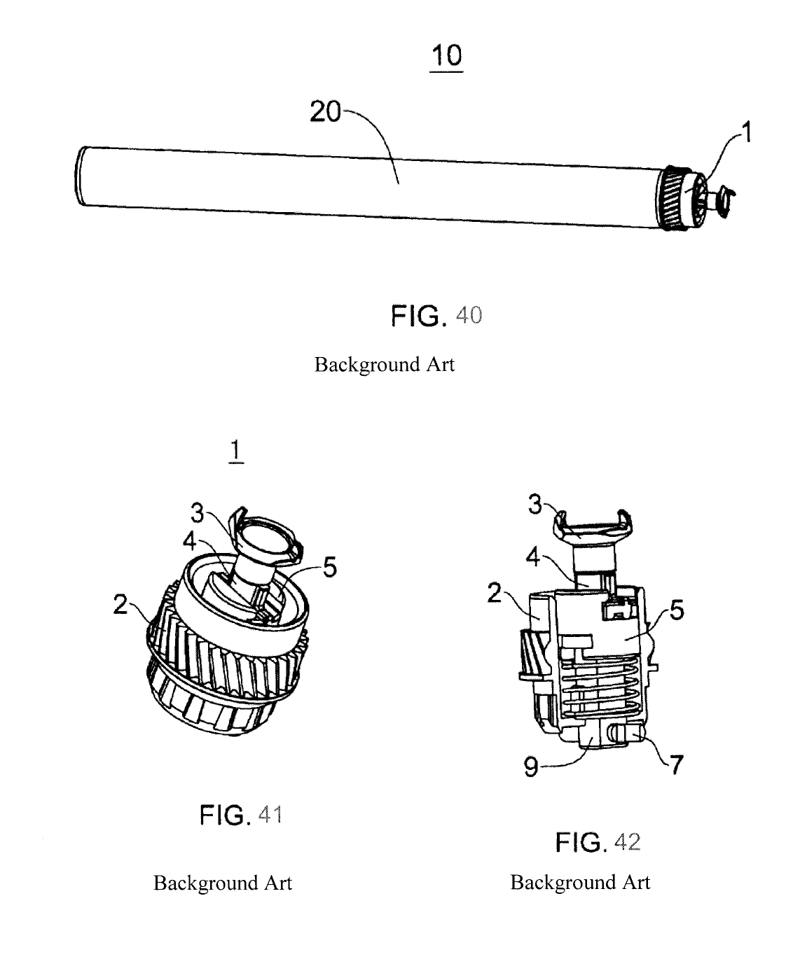

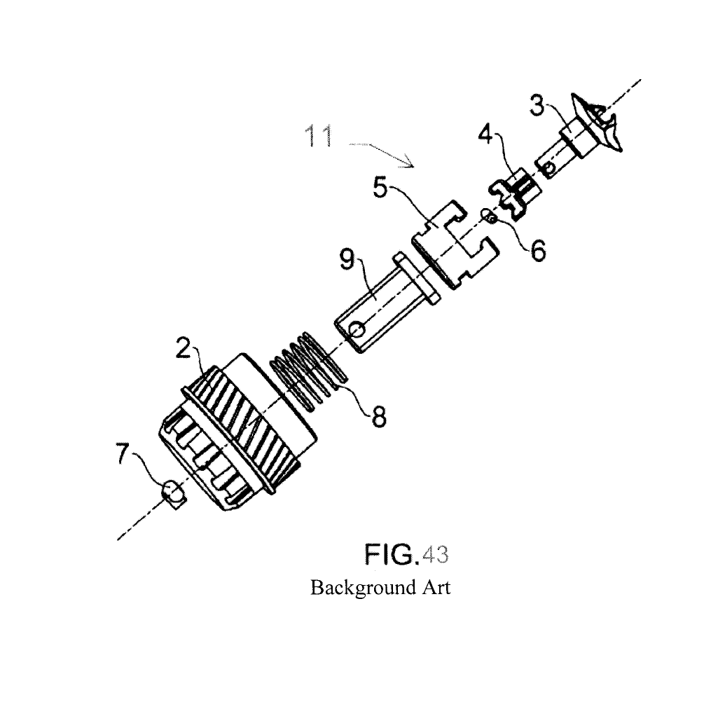

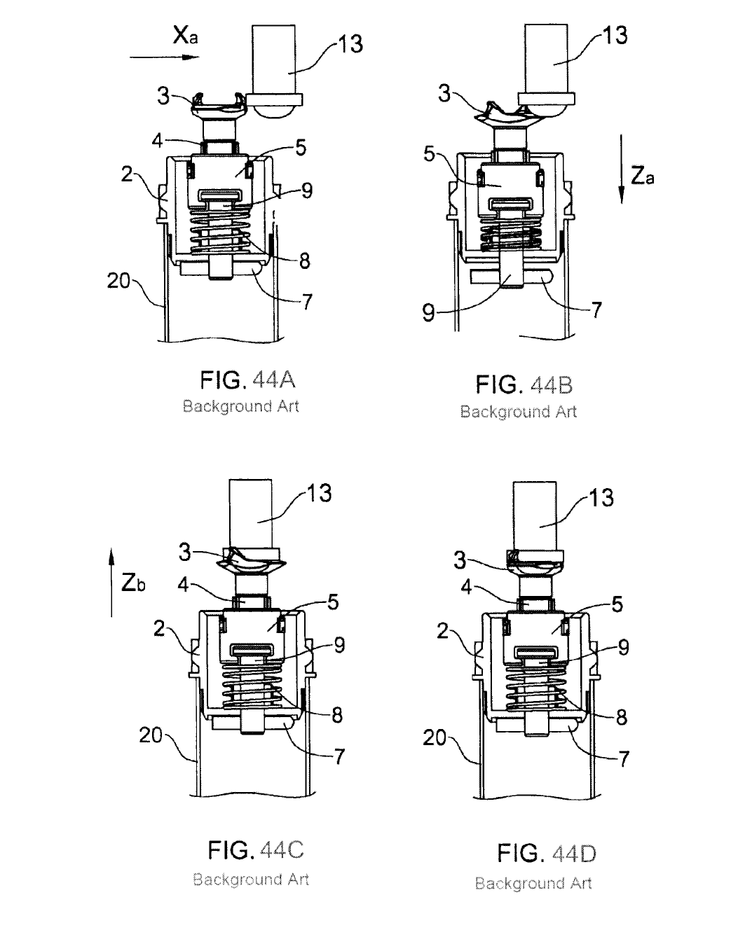

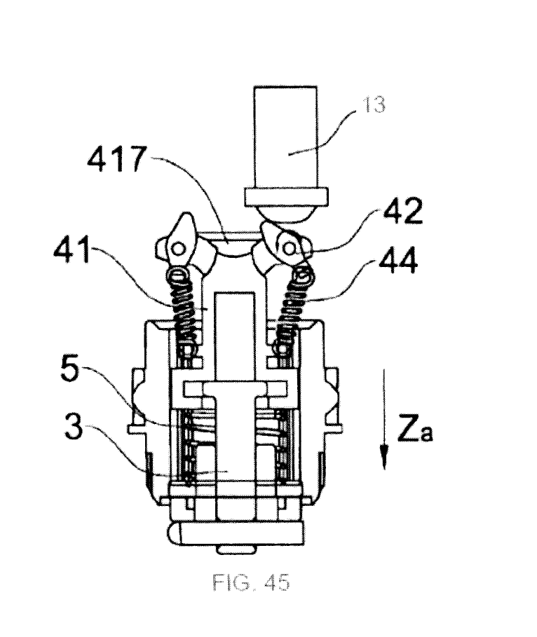

In an alternative embodiment, as shown in FIGS. 39A-39C, the receiving members 768′ are cylindrical and the openings 734a′ have the same diameter as the diameter of the receiving members 768′. Thus, the fit between the receiving members 768′ and the openings 734a′ is a friction fit to retain the sleeve 730 on the gear member 760.

In an alternative embodiment, the openings 734a can be replaced with projections having the same shape as the receiving members and extending from a bottom face of the protrusion 734. The ledge 466 of the gear member 760 can include openings to receive the projections from the sleeve 730.

A transmission unit, such as transmission unit 420 or transmission unit 520 can be used with the gear members 660, 760 and sleeves 630, 730 discussed above. Alternatively, the sleeves 630, 730 can be modified, as necessary, to use with other transmission members described herein, including the transmission member described in the background section of the present application. For example, the sleeves 430, 530, 630, 730 can be modified such that the cylindrical body does not cover the guiding grooves 324. Thus, the pin 40 can be inserted through the sleeve to hold the transmission unit in place after the transmission unit is assembled with the sleeve.

In another exemplary embodiment of a transmission device, the sleeve can be welded to the gear member, for example, by ultrasonic welding. After the gear member and sleeve and assembled, then the surfaces of each component that engage one another can be joined via ultrasonic welding. For example, the ultrasonic welding can occur in the embodiment shown in FIGS. 39A-39C between the receiving members 768′ and the openings 734a′. The ultrasonic welding can be combined with the friction fit and snap fit embodiments above to provide a more permanent attachment of the transmission member to gear member and to assure proper orientation of the transmission device. Other means of assuring proper alignment can be used such as pins, or raised portions which communicate with corresponding recesses in the mating part. The size and shape of such projections and recesses is not important.

The structure described above, including the transmission unit, the sleeve, and the gear member can each be made of metal and/or of plastic. In an exemplary embodiment, the gear member and the sleeve is a two-part member in which the gear member and the sleeve are each a zinc die-cast part, which are united by insert molding such that the sleeve cannot be disassembled from the gear member. In an alternative embodiment, the gear member and the sleeve can each be made of resin and then assembled as discussed above without insert molding. Thus, the sleeve can be disassembled from the gear member such that either part can be replaced, if necessary. The transmission unit can also be disassembled from the sleeve and gear member and replaced, if necessary.

When any of the transmission devices described herein is used, the shell is fastened to a photosensitive drum which is adapted for installation in a toner cartridge, and the engagement structure of the transmission unit sticks out of an end of the toner cartridge. When the user puts the toner cartridge into a housing of an electronic image forming apparatus, the engagement structure of the transmission unit will be engaged with a drive member of the electronic imaging device located in the housing in such a way that a part of the drive member of the electronic imaging device is received in the receiving space and the engagement concaves are received and engaged with two pillars of the drive member of the electronic imaging device respectively so that the photosensitive drum will be driven to rotate by the drive member of the electronic imaging device.

The exemplary embodiments of the transmission device described herein are simpler in structure than the conventional ones, and the way that the transmission device is connected with and separated from the drive member of an electronic image forming apparatus is different from the conventional ones. By the feature that the transmission unit can move along the drum axis L and rotate about the drum axis L at the same time and the specially designed shape of the engagement blocks of the transmission unit, no matter what angle the transmission device is presented when entering or exiting the housing of the electronic imaging device, the transmission unit will be connected with the drive member firmly and separated from the drive member smoothly.

The detailed processes of how the transmission device is connected with and separated from the drive member are disclosed in the pending U.S. patent application Ser. No. 14/461,011, which is hereby incorporated herein in its entirety by reference, and not described in as much detail herein.

The foregoing description of the exemplary embodiments has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. A transmission unit, comprising:
a gear member including at least one ledge on an interior face of the gear member and at least one receiving member having an opening facing the ledge;
a sleeve removably attached to the gear member, the sleeve including a guiding groove and at least one protrusion extending radially outward; and
a transmission unit including a shaft having at least one protrusion extending radially outward from the shaft,
wherein the guiding groove is shaped such that the protrusion is moveable within the guiding groove in an axial direction and rotatable relative to the guiding groove.

2. The transmission unit according to claim 1, wherein the opening of the receiving member of the gear member is arranged such that the sleeve is removably attached within the gear member by axially inserting the sleeve into the gear member and then rotating the gear member until the protrusion of the sleeve is positioned within the opening of the receiving member.

3. A transmission unit, comprising:
a gear member;
a sleeve removably attached to the gear member, the sleeve including a slot on a top face and at least one retention member that forms a guiding groove; and
a transmission unit including a shaft having at least one protrusion extending radially outward from the shaft, wherein
the guiding groove is shaped such that the protrusion is moveable within the guiding groove in an axial direction and rotatable relative to the guiding groove, and
the slot on the top face of the sleeve is sized to allow the protrusion to pass through the slot when the transmission unit is assembled with the sleeve.

4. The transmission unit according to claim 3, wherein the guiding groove includes an opening to allow the protrusion to pass through after passing through the slot when the transmission unit is assembled with the sleeve.

5. The transmission unit according to claim 3, wherein
the at least one retention member of the sleeve includes a first retention member and a second retention member spaced apart from the first retention member such that a gap is formed between the first retention member and the second retention member, and
the gap is sized to allow the protrusion to pass through the gap after passing through the slot when the transmission unit is assembled with the sleeve.
